(19) United States
(12) Patent Application Publication
(10) Pub. No.: US 2025/0117223 A1
(43) Pub. Date: Apr. 10, 2025

(54) SYSTEMS, CIRCUITS, METHODS, AND ARTICLES OF MANUFACTURER FOR DRAM-BASED DIGITAL BIT-SERIAL VECTOR COMPUTING ARCHITECTURE

(71) Applicant: University of Virginia Patent Foundation, Charlottesville, VA (US)

(72) Inventors: Kevin Skadron, Charlottesville, VA (US); Deyuan Guo, Santa Clara, CA (US); Farzana Ahmed Siddique, Charlottesville, VA (US); Lingxi Wu, Charlottesville, VA (US); Ashish Venkat, Charlottesville, VA (US)

(21) Appl. No.: 18/908,472

(22) Filed: Oct. 7, 2024

Related U.S. Application Data
(60) Provisional application No. 63/542,975, filed on Oct. 6, 2023.

(51) Int. Cl. G06F 9/30; G06F 9/38

(52) U.S. Cl. CPC G06F 9/30047; G06F 9/30029; G06F 9/30145; G06F 9/3814

(57) ABSTRACT

Disclosed are various approaches for bit-serial computing embedded in the DRAM subarray, leveraging the massive parallelism of DRAM row operations. The present disclosure discloses digital techniques that can outperform analog charge-sharing techniques. Digital techniques can use more area but support a wider range of computing primitives, and allow a sequence of logic operations to be performed at higher clock speeds, be-tween slower subarray row reads/writes. The present disclosure describes a range of bit-serial architectures, and evaluate raw performance as well as area and energy efficiency. Results show that the digital architecture demonstrates 20× speedup over CPU, 5× over GPU, and 1.7× over SIMDRAM, an analog architecture.

### CROSS-REFERENCE TO RELATED APPLICATIONS

This application claims the benefit of and priority to U.S. Provisional Patent Application 63/542,975 entitled “Systems, Circuits, Methods, and Articles of Manufacture for DRAM-based Digital Bit-Serial Vector Computing Architecture,” and filed on Oct. 6, 2023, which is incorporated herein by reference in its entirety.

### STATEMENT REGARDING FEDERALLY SPONSORED RESEARCH OR DEVELOPMENT

This invention was made with government support under Grant No. HR0011-23-3-0002, awarded by the Department of Defense. The government has certain rights in the invention.

### BACKGROUND

For applications with large datasets and low computational intensity (ops/byte), today's computer systems are bottle-necked by memory access bandwidth. These observations have motivated periodic attempts over the past several decades to place computational capabilities inside the Dynamic random-access memory (DRAM). More recently, the slowdown in Moore's Law and the vast difference in data bandwidth accessible to the processor compared to that inside the DRAM has motivated a renewed look at DRAM processing in memory (PIM).

### SUMMARY

An aspect of an embodiment of the present invention includes, but not limited thereto, a digital bit-serial vector computing architecture embedded in DRAM subarray, and system integration solution of this architecture. The architecture consists of bit-serial logic unit per subarray column, bank-level bit-serial control logic, and rank level processing unit. The bit-serial logic unit can alternatively support various set of bit-serial operations and different number of bit registers with tradeoffs. One advantageous innovation of this architecture, among others, is that the execution time of each bit-serial logic operation is much lower than typical memory row cycle, by decoupling the execution from memory row access. The system integration solution includes memory-first and accelerator-first deployment model, off-loading execution model, taking advantage of subarray-level parallelism, virtual memory support, and evaluation methodology.

An aspect of an embodiment of the present invention systems, circuits, methods, computer readable medium, and articles of manufacture comprises, but not limited thereto, one or more of the following: a) DRAM-based bit-serial vector computing architecture, b) bit-serial vector computing embedded in the DRAM subarray, leveraging the massive parallelism of DRAM row operations, c) subarray-level, bit-serial PIM, including the design space for digital bit-serial logic, for both memory-first (low PIM overhead) and/or accelerator-first (optimized for PIM) deployment scenarios, and d) rank-level unit (RLU) as a PIM controller, offloading the memory controller and orchestrating the PIM computation at the rank level, and wherein the RLU also performs reductions and other tasks that are not strictly data-parallel.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device non-functional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

It should be appreciated that any of the components or modules referred to with regards to any of the present invention embodiments discussed herein, may be integrally or separately formed with one another. Further, redundant functions or structures of the components or modules may be implemented. Moreover, the various components may be communicated locally and/or remotely with any user/operator/customer/client or machine/system/computer/processor. Moreover, the various components may be in communication via wireless and/or hardwire or other desirable and available communication means, systems and hardware. Moreover, various components and modules may be substituted with other modules or components that provide similar functions.

It should be appreciated that the device and related components discussed herein may take on all shapes along the entire continual geometric spectrum of manipulation of x, y and z planes to provide and meet the environmental, anatomical, and structural demands and operational requirements. Moreover, locations and alignments of the various components may vary as desired or required.

It should be appreciated that various sizes, dimensions, contours, rigidity, shapes, flexibility and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility and materials as it pertains to the components or portions of components of the device, and therefore may be varied and utilized as desired or required.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, or method steps, even if the other such compounds, material, particles, or method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

Additional descriptions of aspects of the present disclosure will now be provided with reference to the accompanying drawings. The drawings form a part hereof and show, by way of illustration, specific embodiments or examples.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a drawing of Bi-serial addition example, according to one embodiment described herein.

FIG. 2 illustrates a drawing of an In-situ bit-serial computing in DRAM, according to one embodiment described herein.

FIG. 3 illustrates a drawing of Bit-serial logic unit design space, according to one embodiment described herein.

FIG. 4 illustrates a drawing of DRAM-BitSIMD architecture, according to one embodiment described herein.

FIG. 5 illustrates a Bit-serial programming process for 1-bit addition, according to one embodiment described herein.

FIG. 6 illustrates a Bit-serial int add/sub microprograms on DRAM-BitSIMD, according to one embodiment described herein.

FIG. 7 illustrates a comparison of CPU and DRAM-BitSIMD histogram kernel, according to one embodiment described herein.

FIG. 8 illustrates a graph of the speed up and energy saving for DRAM-BitSIMD, according to one embodiment described herein.

FIG. 9 illustrates a graph of the speed up and energy saving for BitSIMD, according to one embodiment described herein.

FIG. 10 illustrates a graph of the speed up and energy saving for BitSIMD-3Reg, according to one embodiment described herein.

FIG. 11 illustrates a graph of the speed up and energy saving for DRAM-BitSIMD, according to one embodiment described herein

FIG. 12 is a block diagram illustrating an example of a machine upon which one or more aspects of embodiments of the present invention can be implemented according to one embodiment described herein.

FIG. 13 illustrates Table 1 for a cycle count, according to one embodiment described herein.

FIG. 14 illustrates Table 2 for selected benchmarks, according to one embodiment described herein.

FIG. 15 illustrates Table 3 for area and power BSLU variants, according to one embodiment described herein.

FIG. 16 illustrates is drawing of another DRAM-BitSIMD architecture, according to one embodiment described herein.

FIG. 17 illustrates a drawing of the BSLU design space for different choices of operations and number of bit registers, according to one embodiment described herein.

FIG. 18 illustrates a BSLU pitch matching tiling strategy, according to one embodiment described herein.

FIG. 19 a programming process for DRAM-BitSIMD, according to one embodiment described herein.

FIG. 20 includes listings of microcode examples, according to one embodiment described herein.

FIG. 21 illustrates a drawing of DRAM-BitSIMD as CXL Type 3 Device, according to one embodiment described herein.

FIG. 22 includes graphs of equivalent row height and power results of a single BSLU of all variants from RTL synthesis, according to one embodiment described herein.

FIG. 23 includes graphs of throughput per chip area, according to one embodiment described herein.

FIG. 24 includes graphs of speedup and energy reductions, according to one embodiment described herein.

FIG. 25 includes graphs of speedup and energy reductions, according to one embodiment described herein.

FIG. 26 includes additional graphs of speedup and energy reductions, according to one embodiment described herein.

FIG. 27 includes a Table of high level operations, according to one embodiment described herein.

FIG. 28 includes a Table of benchmark, according to one embodiment described herein.

### DETAILED DESCRIPTION

The embodiments of the present disclosure relate to systems, circuits, methods, and articles of manufacture for DRAM-based Digital Bit-Serial Vector Computing. For applications with large datasets and low computational intensity (ops/byte), today's computer systems are bottle-necked by memory access bandwidth. These observations have motivated periodic attempts over the past several decades to place computational capabilities inside the DRAM. More recently, the slowdown in Moore's Law and the vast difference in data bandwidth accessible to the processor compared to that inside the DRAM has motivated a renewed look at DRAM processing in memory (PIM).

One research direction has been to leverage the bit-level parallelism available in the local row buffers in each subarray. A DRAM access reads an entire row of 4K-8K bits from the selected subarray in each chip, multiplied by the number of chips in a rank (typically 4-8). Implementing some computation capability bit position enables massive bulk bitwise parallelism. This approach is often called in-situ PIM. The design space for in-situ PIM architectures involves jointly optimizing the capabilities of the per-bit digital logic while imposing minimal overheads in area and power to leverage best the massive parallelism offered by the subarray. Accordingly, the embodiments of the present disclosure relate to various approaches in this complex design space.

The bit-serial vector computing paradigm allows massive bitwise data-level parallelism to be realized by laying out data in a vertical column-major fashion. This means that operating on an entire word requires a series of bit-serial steps. Prior work on bit-serial computing in DRAM leverages charge sharing on the bitlines, in which two or more operand rows are activated, and the charge sharing performs a simple Boolean computation. This analog approach is some-times called processing using memory (PUM). While bit-serial computing requires a series of DRAM row activations, each row activation can operate on an entire row's worth of bits. These bit slices are 4-8K bits per chip, multiplied by the number of chips in the rank, enabling massive parallelism that dwarfs the small number of steps required to complete a full-word (e.g., 32-bit) computation. In addition, up to one-half of the subarrays in each bank and in each chip can be activated simultaneously.

With 32-64 subarrays per bank, subarray-level parallelism (SALP) substantially increases the computing throughput, although activating several subarrays simultaneously requires more power than traditional DRAM chips and system interfaces are designed to support.

If applications can indeed benefit from such high degrees of parallelism, new PIM-enabled memory products support higher power draw. Until then, we envision that the in-situ PIM design space broadly divides into two markets-“memory-first” and “accelerator-first” PIM. Memory-first designs focus on adding PIM features with minimal area/power overhead so that the resulting product fits in existing memory-system design constraints and has minimal impact on memory capacity. This limits subarray-level parallelism (SALP) and other PIM features. Moreover, memory-first designs require supporting PIM computation while simultaneously satisfying conventional memory accesses, entailing important system design considerations. First, the memory allocator must ensure that physically contiguous memory regions are always available for PIM computations, potentially necessitating periodic defragmentation. Second, although address interleaving is somewhat configurable in most modem systems, individual 8-bit or 16-bit chunks in a cache line are typically spread across the chips in a rank of DRAM, allowing for efficient retrieval of cache lines, but this means that a memory-first deployment with a conventional row-major data-layout cannot assume that the bytes of an individual word are even in the same DRAM chip. For vertical data layouts, this may require that data transposition is implemented on the DRAM module or in the memory controller, which can fetch the bytes from the appropriate locations and then transpose, reuniting the bytes of a word into a single column within the subarray. Further, note that successive cache lines from a physical memory page are spread across channels and could also be spread across ranks and banks.

Accelerator-first PIM seeks to design the best data-parallel accelerator and uses DRAM as an implementation technology to achieve this without the constraints of the traditional memory interface. Data in an accelerator-first architecture can still be read and written by the processor, for example, via CXL, but data capacity and host read/write bandwidth would be lower and device power higher than what a traditional memory interface supports. For example, in the present disclosure, a discussion is included for an exploration of the degree of SALP. For purposes of the present disclosure, it is assumed such an accelerator would be deployed as a separate accelerator board attached to the PCIe bus, very much like a discrete GPU. This allows it to draw much considerably more power, even as much as a GPU. Our exploration shows that the accelerator-first approach can outperform state-of-the-art GPUs by 5× for memory-bound data-parallel tasks, with much lower power and, thus, much better energy efficiency.

In addition to the deployment models, the complexity of the bit-serial logic embedded into the DRAM itself is another key axis that is explored, as it has important performance implications. First, we explore the number of bit registers that could be accommodated within the bit-serial logic to avoid a “register spilling” effect, where extra row accesses are needed to store intermediate results. Second, we explore various configurations of a bit-serial logic unit (BSLU) that differ in the number and types of operations they can support, offering interesting power-performance-area tradeoffs. In particular, the present disclosure includes an exploration of: 1) ANAND-only version as the minimum logic complete design, 2) A MAJ3+NOT design as a digital point of comparison to charge-sharing triple row activation, 3) An XNOR+AND+SEL design that performs search and conditional update primitives of Associative Processing, and 4) A much more capable design adding XOR/OR.

It is also observed that a sequence of logic operations on local registers in the BSLU can operate at a higher frequency than subarray reads/writes. Logic operations are limited by the latency of propagating control signals to all columns, modeled as tCCD, a timing parameter describing the latency between two DRAM column commands. This can be 5-10× faster than a regular row access cycle involving row activation and precharge. The BSLU execution is decoupled from a read and write operation of a respective DRAM subarray. This decoupled execution model is unique to digital in-situ PIM solutions and infeasible for charge-sharing based solutions which tie the PIM computation to row access and is another novel contribution over prior bit-serial PIM approaches such as Micron's IMI architecture.

Some advantages described in the present disclosure includes:
An exploration of the design space for digital bit-serial in-situ techniques across several key axes, including deployment models (memory-first vs. accelerator first), bit-serial logic complexity (simple vs. complex operation sets and number of bit-serial registers) and evaluates the relevant power-performance-area tradeoffs of the various designs in a detailed technical evaluation that compares against CPU, GPU, and analog PUM (using SIMDRAM) baselines.
An evaluation of the programmability aspect of in-DRAM bit-serial computing with the help of a lightweight but comprehensive bit-serial ISA that includes memory row read and write, bit-serial logic operations, and depending upon the design configuration, may support one or more local bit registers, as well as register manipulation operations such as move and set. This allows one to support 30+ high-level operations, including arithmetic (integer and floating-point), logical, relational, etc., implemented using a microcode approach.
A rank-level processing unit (RLU) which serves two purposes. First, it acts as a controller to issue commands to the DRAM to run a PIM computation kernel. Second, the RLU can access memory in a conventional way, thus enabling it to support any tasks that require cross-column data access, allowing it to implement tasks such as reductions, shifts, and transpositions. The RLU avoids the need to implement them in the memory controller.
The system integration of various bit-serial designs with the host system, including interaction with the memory controller, integration into the address space, mechanisms for the host CPU to launch compute kernels and retrieve results, and support for concurrent utilization of PIM-enabled memory between different PIM-enabled processes as well as between PIM-and non-PIM processes.

### 2. Overview

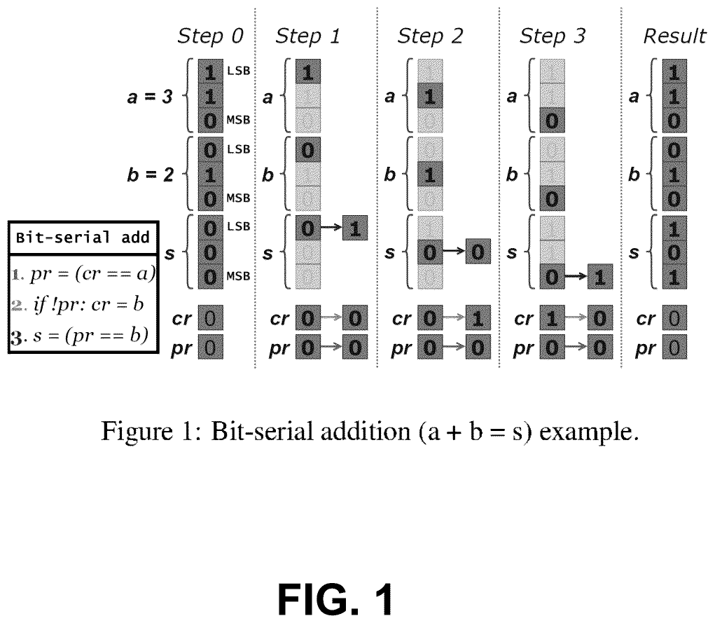

Bit-Serial Computing. FIG. 1 illustrates the bit-serial addition of two 3-bit words. The result is computed sequentially from its LSB to MSB, and each bit position is computed by applying three logic operations. This particular example leverages two additional registers, namely er and pr, for storing carry and intermediary bits respectively. Other arithmetic, relational, and logical operations can be synthesized similarly by executing different logical steps at each bit position. While traditional (i.e., bit-parallel) computing can compute results in one shot, bit-serial computing can outperform it by simultaneously operating on a large vector.

In-DRAM Bit-Serial Computing. Bit-serial computing in DRAM involves operating on the values either (1) on the bitlines, with the result bit captured by the sense amplifier, in the case of analog PIM, or (2) in the local row buffer, in the case of digital PIM, with the operand(s) coming from either/both the local row buffer and/or a designated one-bit register, and the result either written back to the local row buffer or written to a designated bit register (or two registers, in the case of arithmetic, where a carry bit is also needed).

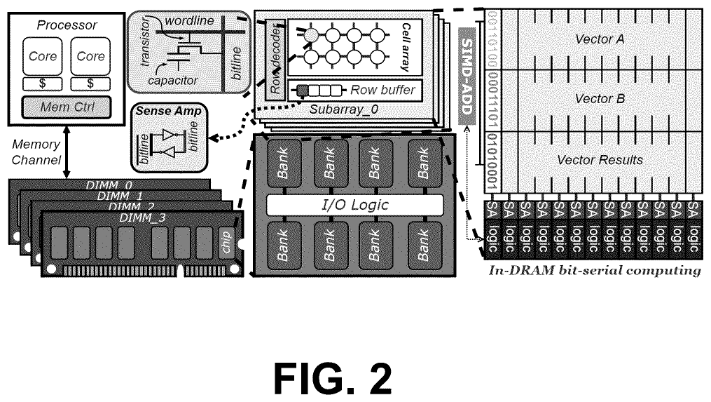

It has been demonstrated by others that the benefits of leveraging a vertical data layout to perform massively parallel bit-serial SIMD-style processing. The key idea is to treat each bitline as a vector lane and align the source and destination data elements vertically on top of each other, as shown in FIG. 2. A series of subarray row activations perform the computation sequentially at each bit position. The vertical layout allows each activation to access a bit slice across a row of vector elements (i.e., bitlines or vector lanes). Two additional advantages of the vertical layout are that it enables arbitrary bit access within the operands (e.g., left or right shifting within each word is cheap) and it supports flexible operand size, without having a word spread across multiple chips.

Limitations of Analog Approaches. Many prior architectures leverage DRAM's analog property by connecting three DRAM rows to the sense amplifiers, AKA triple-row-activation (TRA), to force charge-sharing at the row buffer, equivalent to performing a row-wide bitwise logical operation. More complex operations, such as arithmetic, can be synthesized as a sequence of logical operations. However, analog-based bit-serial DRAM computing has the disadvantages of high latency and energy overhead. First, sustaining the activation of each additional wordline has been shown to require 22% more energy. Second, there is a substantial latency in setting up operand rows in a designated compute region (a group of 16 DRAM rows with an additional row decoder) and copying the result row back to the regular data storage region in the DRAM subarrays. Moving operand rows to and from a dedicated compute region is needed for analog in-DRAM computing because (1) charge-sharing destroys the values in the original rows, and (2) selecting three arbitrary rows to activate requires a large row decoder.

Design Space of Digital Bit-Serial PIM. An alternative approach is integrating digital logic to each sense amplifier. In this case, the sense amplifier and 1-bit compute logic are pitch matched, and an arbitrary operand row can be selected and latched into the local row buffer for subsequent computing. For a single 8-Gbit DDR4 chip (8 banks/chip) with 16K bitlines per bank, there would be 128K 1-bit processing elements. The degree of hardware parallelism can be further increased with subarray-level parallelism, although the degree of SALP is limited by power delivery. Digital bit-serial processing significantly reduces the latency and energy spent on the intra-subarray data movement and only requires traditional, single-row activation. There is a design space to be explored by varying the capability of the integrated bit-serial logic to get different power, latency, area, and performance profiles while achieving varying degrees of flexibility, versatility, and programmability. This work highlights key design considerations and discusses the associated tradeoffs of different bit-serial PIM designs for massively data-parallel computing.

Bit-Serial Computing Performance. To illustrate the performance potential of an in-DRAM bit-serial architecture, we provide a simple back-of-the-envelope calculation below. In-DRAM bit-serial computing relies on cycling through operand rows for processing. For integer addition (a+b=c), a performance-optimized design (e.g., see Section 6.1.2) requires two DRAM reads (fetch ith bits of a and b into row buffer logic) and one DRAM write (writeback ith bit of c to DRAM row) at each bit position. One DRAM row cycle takes a minimum of ˜40 ns (tRAS+tRP). Therefore, adding two 64-bit integers requires a total of 64×3×40=7,680 ns. In contrast, a modest CPU core clocked at 2.5 GHz can perform a 64-bit integer addition in one cycle (0.4 ns), which is 19,200 times faster.

However, DRAM bit-serial PIM is optimized for throughput. To break even with the CPU's performance on a vector operation, the PIM only needs to achieve 19,200-way parallelism xn cores to beat an n-core CPU-for example, the PIM would need to achieve 614,400-way parallelism to beat a 32-core CPU. A DDR4 8 Gib_x4 chip has 16,384 bitlines (i.e., vector lanes) per subarray, and a rank of such chips can process 262, 144 bits in a SIMD manner, outperforming the CPU by a factor of 81×. This means that even without SALP, PIM's performance advantage over the CPU is large enough to accommodate the additional overheads in end-to-end execution, such as data transposition and the cost to launch a PIM computation and return the result to the CPU. Moreover, multiple DRAM subarrays can operate in parallel due to the rank-, bank-, and even subarray-level parallelism, achieving the effect of an extremely large vector machine. For example, a 256 GB bit-serial processing enabled DRAM system (16 ranks of 8 Gib chips without subarray-level parallelism) can sustain a 16,777,216 bits/DRAM row cycle peak processing rate, translating to 2.2×10¹² 64-bit integer addition per second. That means a total of 9, 166 aforementioned CPU cores are needed to achieve the same level of parallelism.

### 3. Related Work

Charge Sharing Based Solutions. A key direction for DRAM in-situ PIM solutions is based on charge sharing, which activates multiple rows simultaneously and performs a simple Boolean operation on them. This approach minimizes DRAM circuit modification and area overhead. Examples include Ambit, bit-serial addition, SIMDRAM, and ELP2IM. However, charge-sharing-based solutions still require row decoder modification to activate multiple rows and often need dual-contact cells to achieve the NOT functionality. ComputeDRAM demonstrates the possibility of multi-row activation with unmodified DRAM by intentionally violating DRAM command timing constraints, but it also requires storing the negation of all data due to the lack of NOT functionality. It works with some current-day DRAM products, but not all. These solutions often require multiple row copies, both because multi-row activation can destroy the original row contents, and to place the operands into special rows designated for computation. Furthermore, the reliability of charge-sharing-based solutions can be impacted by process variations. The PIPF-DRAM work demonstrates that bit-serial operations can be done based on precharge-free DRAM (PF-DRAM). The main idea of this architecture is to activate multiple rows consecutively rather than simultaneously, and the charge sharing happens among a sequence of activations. However, this solution faces the same challenges as other charge-sharing-based solutions: a limited set of supported operations and the need for extra row copies.

Other Digital Bit-Serial Solutions. Micron's In-Memory Intelligence (IMI) [H)] demonstrates the potential of attaching bit-serial logic to SAs, even though it was ultimately not brought to market. DRISA-ITIC-mixed solution attaches XNOR/NOT gates to SA as a complement of charge-sharing based AND/OR. The exploration undertaken in this work significantly expands the scope of these works by considering a more complete and versatile microcode ISA with bit registers and proposing novel performance optimizations through de-coupled execution of memory access and bit-serial operations.

Associative Processing Solutions. Associative processing is a bit-serial technique based on search and update operations. The search only requires comparison, and the update writes new values based on a bitmask (typically produced by the comparison). This approach can leverage content address-able memory (CAM) and lookup-table (LUT) PIM features. CAPE, pLUTo, and LAcc are examples of this style. However, arithmetic beyond simple integer add/subtract can be expensive, and prior work has not implemented a floating-point. Sieve and DRAM-CAM are designed for accelerating pattern matching with vertical data layout, with pop count peripheral circuits for result reduction, but lack generality to support other types of computation.

PIM with Bit-Parallel Processing Units. Several proposed architectures place processing units that can operate on full words in one step, at subarray, bank, or rank level, without modifying the subarray itself, such as BLIMP-V. Fulcrum is an in-situ solution for 3D-stacked memories such as HBM and implements scalar, bit-parallel processing units at the edge of each pair of subarrays. However, it requires three local row buffers to hold the operand rows and the destination row, and support for left/right shift. An advantage of a fully featured processing unit is that they are not limited to data-parallel operations; for example, they can support conditionals, reductions, etc. However, they require changing the address interleaving, thus affecting regular memory transactions.

Commercial products such as AiM and Aquabolt introduce low-cost multiplication and addition units to accelerate specific deep-learning tasks. However, such solutions lack flexibility and cannot exploit the massive subarray parallelism.

PIM Compiler Support. A compilation framework has been introduced by others based on LLVM for the BLIMP PIM architecture, which features a bank-level design incorporating a general-purpose RISC-V processor. They assume that the host CPU would stall until the PIM application completes execution. Vadibel develop a compiler framework that employs polyhedral optimization techniques. Wang focused on a PIM compilation framework based on the TensorFlow model. Both impose restrictions on the underlying data representation, limiting applications to matrix operations. The techniques described in this work, in contrast, impose no such constraints. Hadidi implemented a compilation framework for instruction-based PIM offloading, where individual instructions are offloaded for PIM processing. They identify instructions beneficial for PIM execution during compile-time. In contrast, our accelerator-first approach adopts a kernel-based offload model.

### 4.0 Design Space Exploration

The design space of in-situ bit-serial PIM architectures is characterized by several key parameters, including deployment models, power and area constraints, hardware design limitations, programmability aspects, and performance considerations. This section examines each of these in detail and enumerates potential design options.

### 4.1 Deployment Models

Memory-First Deployment. In the memory-first model, area overhead and memory capacity becomes key consideration as we seek to integrate PIM features into conventional DRAM designs. We also need to split memory space for regular usage and PIM computation and consider system integration details such as virtual/physical addresses and memory paging. Thus, the PIM computation capability can be installed in a few subarrays of the DRAM at most, so that area and power overhead are small. In our evaluation, we explore configurations that fit within an area/power overhead budget of 5% or less, and discuss potential system integration solutions in Section 6.

Accelerator-First Deployment. In this model, the PIM computation capability can be installed in a large portion of subarrays, providing us with the flexibility to explore designs that offer varying degrees of subarray-level parallelism (SALP). Although the chip organization such as channels, ranks, and banks can be adjusted or enlarged as a stand-alone accelerator, the present disclosure follows the traditional DRAM organization for simpler analysis. The area overhead of bit-serial logic introduces tradeoffs of performance and capacity given fixed chip area. Because sense amplifiers (SAs) are shared by two adjacent subarrays, up to 50% subarrays can be activated simultaneously and perform PIM computation, while the rest subarrays can be used for storing data or supporting another PIM context in a time-sharing manner.

### 4.2. Complexity of the Bit-Serial Logic

The level of complexity of the bit-serial logic not only affects programmability but has important performance considerations. First, keeping the bit-serial logic simple implies that the number of bit-serial operations required to realize high-level arithmetic and logic operations would increase. Second, and more importantly, it could impact the number of row accesses required for storing intermediate results. Note that row accesses are more costly than logic operations as each memory-row read or write takes a full row activation and precharge cycle, typically 30-50 ns. On the other hand, bit-serial logic operations that only use the value in the local row buffer and local registers can operate faster, at a cycle time determined by the control signal propagation latency across all columns, which is modeled as tCCD, i.e., the delay between consecutive column commands, typically 5-10× faster than a row access cycle, so performance is largely dominated by row access. The running time of a bit-serial program is the sum of the execution time of all row accesses and bit-serial operations in this program. This measurement is slightly pessimistic because some bit-serial operations can potentially overlap with row accesses with proper control sequence or pipelining technique.

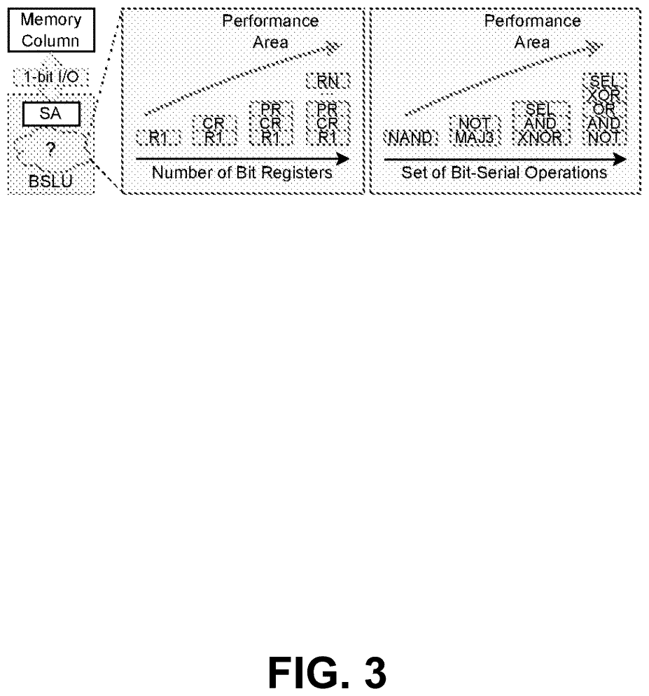

We explore the design space of bit-serial logic units (BSLU) based on ITIC DRAM architecture. In a PIM-enabled subarray, each column has a BSLU pitch-matched and attached to the SA. In some examples, the pitch matching could be such that one of the BSLUs takes up the width of several columns. With vertical data layout, a row read operation can read a bit slice from the memory array to the local row buffer, and a row write operation can write all bits stored in the local row buffer to a specific bit slice—i.e., row-in the memory array. All the BSLUs operate in a lockstep, SIMD style. FIG. 3 shows the model of a BSLU, where row accesses can be abstracted as 1-bit 1/0, and SA can be considered as a 1-bit register. The design space of the bit-serial logic then includes (a) the number of bit registers, and (b) the set of bit-serial operations. Since performance is largely dominated by row accesses, the goal of designing the logic within BSLU is to reduce the number of row accesses at a low area cost.

### 4.2.1. Number of Bit Registers

Introducing one or more additional bit registers can reduce the number of row accesses by leveraging computation locality within BSLU and avoiding the “register spilling” effect. At the same time, more bit registers require more area and register addressing logic. We analyze how different numbers of bit registers affect bit-serial computing as follows.
0 Reg: Ignored due to incapability of performing two-operand Boolean operations.
1 Reg: With one additional bit register besides SA, the BSLU can perform two-operand Boolean operations. With a logic complete set of bit-serial operations, the BSLU can compute complex tasks. But the performance is limited due to the need of storing all temporary values in memory rows.
2 Reg: By adding one more bit register, the BSLU can store a temporary bit value locally which can significantly reduce the number of row accesses, such as the carry bit during integer addition. In addition, the BSLU can support three-operand operations such as conditional selection (SEL).
3 Reg: Adding three bit registers provides more room to store temporary values during complex tasks such as inte-ger multiplication and floating-point arithmetic. Although all BSLUs operate in SIMD style, complex tasks often require column-specific operations based on a condition. For example, for integer vector multiplication A×B=Prod, we may read out a bit slice of A, and use it as a condition to determine in which columns we need to shift and add B to Prod. Thus, there is a need to have three bit registers to store the second operand, the carry bit, and the condition bit, shown as RI/CR/PR in FIG. 3.

N-Reg: More efficiency can be gained with additional registers, but the logic overhead becomes difficult to pitch-match.

### 4.2.2. Set of Bit-Serial Operations

Due to hardware cost, a BSLU can be limited to supporting a small set of native bit-serial logic operations. The following representative set of bit-serial operations and analyze performance and area trade-offs have been studied. More bit-serial operations result in better performance but higher hardware costs.

NAND-only—Minimal Logic Complete Design: This BSLU supports a single universal NAND operation which is logic-complete. It requires the 1-Reg architecture (i.e., the SA plus one bit-register).

MAJ/NOT—Digital Version of Triple Row Activation: This BSLU supports three-input majority (MAJ3) and NOT operations. The MAJ3 operation implements the same computation steps as triple row activation analog PIM by serially reading in three bit operands and computing the majority. NOT is for logic completeness. In some examples, this BSLU uses 2-Reg.

XNOR/AND/SEL—Associative Processing Style: This BSLU supports XNOR, AND and SEL operations. The XNOR operation can check the equality of two bits. Combined with AND, this BSLU can serially match memory data with specific input patterns bit by bit, and use the AND operation to deter-mine if all bits are exactly matched. The SEL operation is for supporting conditional write, so the BSLU can operate in an associative processing style using search+update primitives. In some examples, this BSLU can use 2-Reg.

NOT/AND/OR/XOR/SEL—A General Purpose Setup: We consider this set of Boolean operations as a good balance point between hardware cost and general-purpose computation functionality and performance. The BSLU can use 2-Reg or 3-Reg. The latter is much more efficient for floating-point and integer multiplication.

### 5. DRAM-BitSIMD Architecture

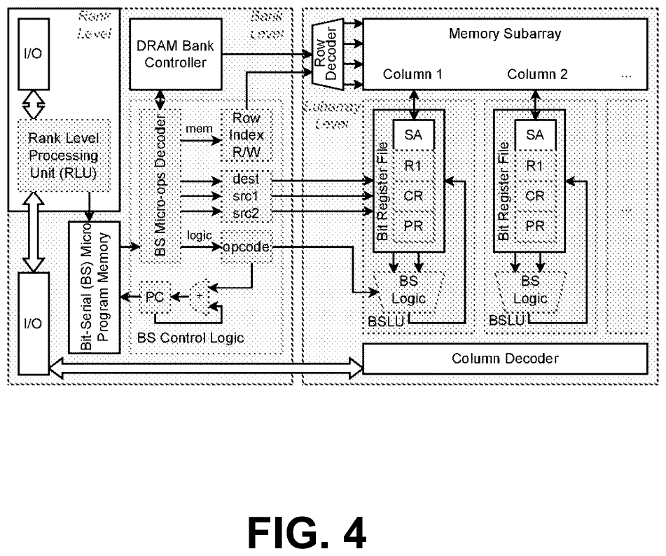

The high-level DRAM-BitSIMD (Bit Single Instruction, Multiple Data) architecture we use to evaluate the design tradeoffs discussed above is shown as FIG. 4. It can include the following components.

Subarray-Level Bit-Serial Logic Unit (BSLU). This is the bit-serial processing element per subarray column. It includes logic circuit to perform various bit-serial operations, bit registers, and register addressing logic. In PIM computing mode, within each subarray, BSLUs associated with each column are operated in lockstep.

The bit-serial ISA of each BSLU variant includes a unique set of bit-serial logic operations described in Section 4.2.2., common register move/set operations, and regular memory row read/write.

Bank-Level Bit-Serial Control Logic (BSCL). At the bank level, there is a BSCL module for decoding bit-serial micro-ops (e.g., micro opcode) and sending control signals to all BSLUs within the bank. For memory read/write operations, the control logic decodes the row index and sends the signals for reading a memory row to the SA or writing the SA to a memory row. For bit-serial logic operations, the decoder decodes opcode and source and destination registers, then sends control signals to the BSLUs to perform the computation. The control logic also updates its PC for fetching next bit-serial micro-ops. The BSCL has a small instruction buffer to store the program. If the program is too large for the buffer, the computing task must be broken into multiple compute kernels.

Rank-Level Processing Unit (RLU). The RLU is a micro-processor that sits on the DIMM and can send commands to each chip and bank, and thus can perform cross-column computation that the subarray-level BSLU does not support, such as reductions. The RLU is also responsible for translating the RISC-V instructions into low-level bit-serial microprograms, using a lookup table indexed by the RISC-V opcode. The sub array row indices in instruction encoding need to be updated based on actual row allocation.

### 6. System Integration

This section describes the software and hardware features that enable interaction with the host system. In this work, we adopt a kernel offloading model, where programmers manually partition the workload to ease the system integration effort. For now, we manually program the PIM kernels; we envision that in the future, a vectorizing compiler with #pragma pim commands could replace much of that effort and that, eventually, the pragma would not be required. We adopt this simplified approach to the programming aspect because this work is focused on architectural exploration and tradeoff analysis.

### 6.1 Programming and Compiling

### 6.1.1 Bit-Serial Microcode

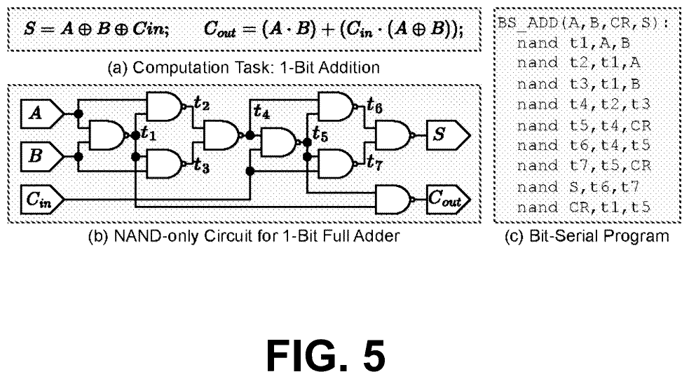

Because the bit-serial architecture uses only a small number of elementary logic elements, writing the microprogram for a bit-serial operation benefits from logic synthesis tools, which can identify the sequence of operations using these hardware elements and any intermediate values. FIG. 5 demonstrates how to map a high-level computation task to a NAND-only bit-serial microprogram. Given a task (a) for 1-bit addition, a NAND-only circuit (b) is created by synthesis tools, then the circuit is converted into a bit-serial NAND sequence with temporary variables (c). Depending on the architecture's actual number of bit registers, some temporary variables may be spilled to rows with extra reads and writes. Compiler backend techniques such as instruction scheduling and register allocation can help to reduce the number of temporary rows.

### 6.1.2 High Level Operations

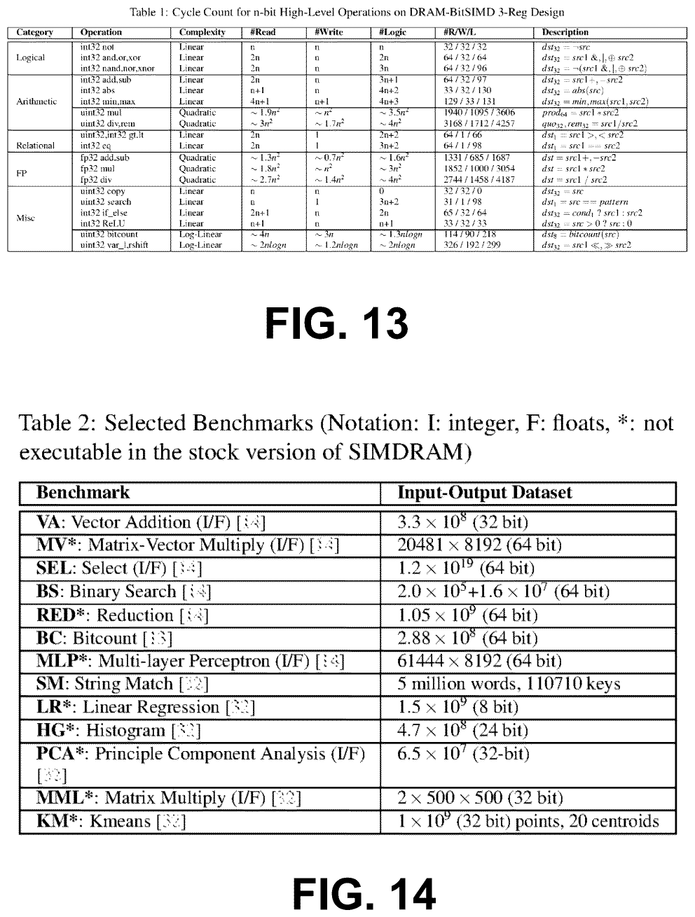

The various embodiments implement a rich set of high-level operations, compatible with a typical vector instruction set, as shown in Table 1 of FIG. 13, including bitwise logical, integer arithmetic, integer relational, floating-point arithmetic, and other supporting operations. With the decoupled row access and bit-serial operation execution, we collect the number of row read, row write, and logical operations separately in the table from a functional simulator for measuring performance. Note that the bit-serial microprograms can likely be optimized further, and the architecture can potentially support more data types and operations.

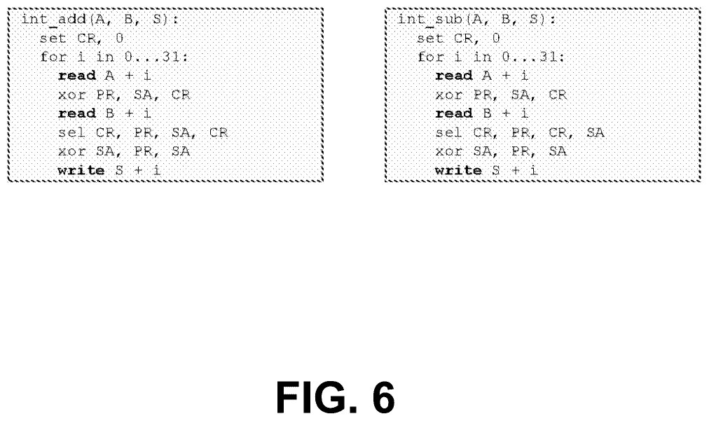

Integer Arithmetic, Relational, and Logic Operations. FIG. 6 shows the microprograms for integer addition and subtraction. They minimize subarray row accesses to just reading out each bit of the two operands and writing back the results by taking advantage of the bit registers (CR/PR) and complex bit-serial operations (XOR/SEL) in the 2-Reg or 3-Reg model. Integer relational operations are implemented based on subtraction, with the necessary sign bit check. If not directly supported by the logic gates in the BSLU, Boolean logic operations are implemented using a short microprogram. The basic shift-and-add approach for integer multiplication has O(n²) complexity. We implement unsigned integer multi-plication with one level of Karatsuba recursion, then fall back to the shift-and-add approach. We implement the shift-and-sub approach for division. Bit-serial addition or subtraction can be done on two ranges of bits, i.e. row indices, without the need for shifting the data.

Floating-point Arithmetic. One of the main challenges with FP arithmetic is that mantissa alignment and result normalization require data-value-specific shifting steps, which contradicts the principles of SIMD. We implement the variable shifting in log-linear complexity by performing conditional shifting with 2; stride.

Miscellaneous Operations. We can also effectively search for an exact pattern among data elements in all columns by encoding the pattern as part of a bit-serial microprogram. The bit-serial ISA supports bit population count (pop count) and variable shift in log-linear complexity.

### 6.1.3. Application Development

We assume a kernel-offloading model and envision that the kernel code can be written in two ways. If the logic is simple, such as a single for loop with no inter-loop conditional or data dependencies, the user can annotate the loop with a pragma, similar to the OpenMP parallel-for, and the compiler would generate vectorized code. An LLVM auto-vectorization routine without user intervention is also possible. In this work, we assume an expert programmer manually identifies kernels to offload and rewrites the applications using custom macros.

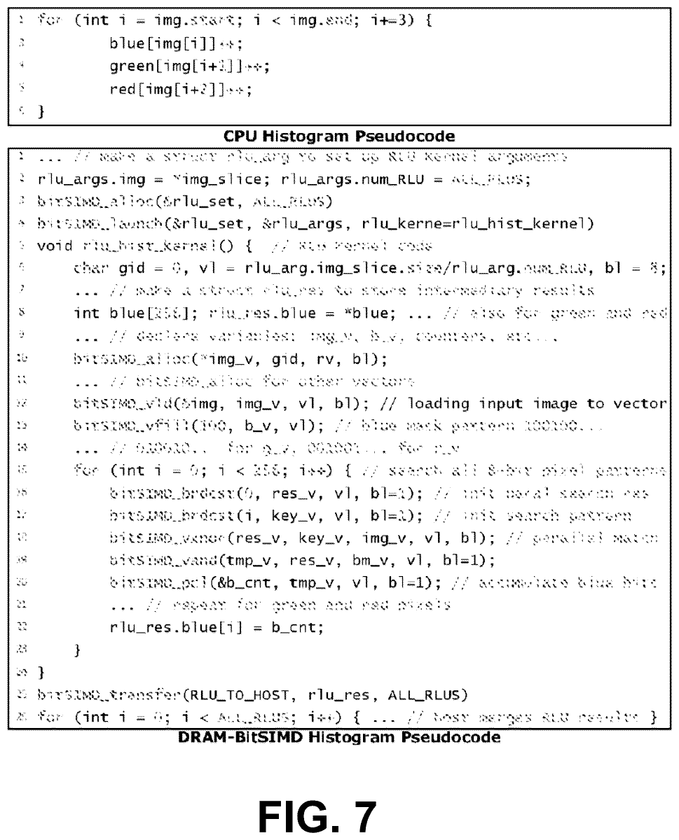

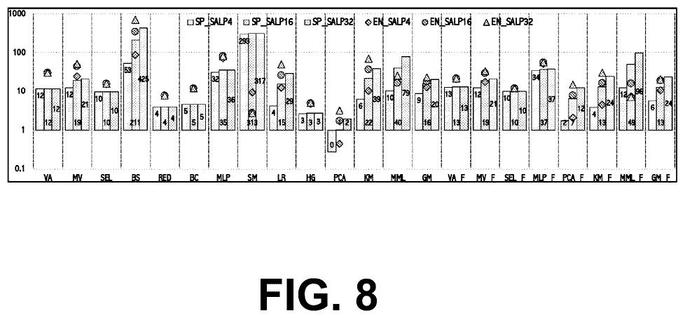

FIG. 7 shows two pseudocode snippets (some details omitted for brevity) comparing the baseline CPU program, and the equivalent DRAM-BitSIMD accelerated code for Histogram. The Histogram kernel computes the frequency of each 8-bit R/G/B pixel pattern in an input image. The input image is a PNG file with interleaved blue, green, and red pixels. The key idea of implementing the Histogram in DRAM-BitSIMD is to perform a parallel bit-serial search of each pixel pattern from 00000000 to 11111111 and accumulate hits. The host first sets up the kernel by allocating RLUs and distributing a slice of the input image to each RLU (lines 1 to 4). Each RLU runs the same kernel code and generates three counter arrays independently. The data is transferred to the host (line 25) post computation. Note no cross-RLU communication is needed. The host handles the final data merging (line 26).

Compilation. As previously described, DRAM-BitSIMD uses two levels of ISAs for programming and execution. The first level (Section:′) is the DRAM-BitSIMD bit-serial micro-ops ISA. The second level (Section 6.1.2 and Table 1 of FIG. 13.) consists of extensible DRAM-BitSIMD high-level operations, aka macros, that manipulate vectors (analogous to RISC-V Vec-tor Extensions). The DRAM-BitSIMD macros are exposed to the programmer as API functions. Each macro is a fixed functional routine (comparable to NVIDIA PTX) agnostic of DRAM-BitSIMD architectural details, which is implemented as a microprogram of low-level BitSIMD ops in the BitSIMD controller at the bank level (FIG. 4). This decouples the backend code generation from being tied to a specific PIM architecture, leaving room for future hardware and software improvement and providing an abstraction for application and compiler developers.

DRAM-BitSIMD kernel and host codes are compiled separately. The kernel is compiled into sequences of high-level DRAM-BitSIMD instructions (Section 6.1.2.) mixed with RLU-compatible instructions (e.g., RISC-V) since the kernel execution is handled by both RLU and bit-serial logic at the subarray. The compiled kernel code is stored in the memory and fetched into the RLU instruction cache at run-time.

### 6.2 Virtual Memory and PIM-Kernel Launch

Virtual Memory. Unlike prior PIM work, the goal is to make BitSIMD designs work with existing OS virtual-memory systems with as few changes as possible. Each bitSIMD_alloc command allocates a data structure to a contiguous virtual memory region. Each data structure can be described with a simple base and size. This does not necessarily map to a contiguous region of physical memory, as we explain below. The allocation fails if the requested allocation is too large for the PIM-enabled memory capacity. Large data structures cannot be allocated a single, contiguous region of physical memory (more on this below), so if the OS cannot allocate the necessary physical-memory regions as needed the allocation also fails. This may motivate OS support for defragmenting memory to support PIM, but that is left for future work. To try to keep space available for PIM operation, the OS's strategy for allocating physical memory to non-PIM processes should try to keep blocks of space free for as long as possible. Another option is to reserve space in systems with high utilization of PIM.

Vertical data layout requires us to allocate n rows together for n-bit words; we call this a word batch of rows. In traditional interleaving, successive physical addresses rotate among channels, ranks, banks, etc. but stay within a given row position until that row is filled and then move to the next row in the same “horizontal set” of subarrays. This works well to accommodate vertical data, but SALP requires that once a data structure has filled a word batch of rows across a horizontal set of subarrays, the next allocation to a word batch should be in a different subarray so that a data structure is spread across as many subarrays as possible to maximize SALP.

We also require the ability to align operands so that operands that are part of the same kernel are mapped in the same way to the same subarrays. This requires the OS memory allocator to understand that a group of operands is related, which is specified by the groupID in the alloc call, as well as word batches and the address interleaving so that once A is allocated, B and S can be allocated to a physical address at appropriate offsets that will align with A.

To achieve these goals, the OS maintains a table mapping base addresses for PIM allocations in virtual memory to base addresses in physical memory. Both the OS and the RLU must agree on how to partition a data structure into chunks that fill a horizontal set of subarrays and then place successive partitions at appropriate offsets in the physical address space so that a data structure is indeed spread across different horizontal sets of subarrays to maximize SALP. If only some subarrays are enabled with PIM, the allocation should ensure that data for PIM computation are only placed in PIM-enabled subarrays. This is deterministic so that the set of allocated regions can be determined by the OS and the RLU simply from the base address and size. These allocated regions of physical memory are pinned and marked non-cacheable. They are also removed from the OS-free list. When the data structure is later freed or the PIM process exits, these allocated regions are released.

This means that once a data structure is successfully allocated, CPU operations on the PIM data structure (loading data or launching a PIM computation kernel) only need to specify the base address and size. This is checked in the mapping table to find the physical base address, so translation and permission checking is very low overhead.

Data allocated in PIM memory are not accessible by regular loads and stores. They may only be accessed through translation functions that load regular data into the PIM in vertical format, retrieve a block of PIM data and convert it back to a traditional layout. For data previously computed by the CPU and where a large portion of the data may reside in the last-level cache, a version of these functions should exist that checks the cache. A streaming version should also exist that bypasses the cache, reading/writing data between traditional and PIM vertical layouts. Both require the involvement of the RLU to perform the appropriate sequence of row accesses to fetch the vertically laid-out data.

Kernel Launch. A PIM computation kernel is invoked with the virtual base address and size for the PIM program and the virtual base address and size for each argument. The program must be smaller than a traditional OS page; its physical address is found using the page table. The kernel calls first invoke the OS. The data arguments are checked in the OS PIM-mapping table, producing the physical base addresses for the arguments. These are passed with the structure sizes to the RLU by writing them into a descriptor in memory, along with the specific command to be performed (loading data, kernel execution, etc.). Then launching the kernel is performed with a jpim instruction that transfers control to the memory controllers and stalls the CPU core. There is no communication between channels during a PIM operation, so it is sufficient for the CPU to broadcast the jpim; the memory controllers do not need to coordinate. However, the memory controller should not reorder memory operations across a PIM operation. Initiating the PIM operation on the RLU only requires a 1-bit “go” signal per rank from the memory controller. The RLU fetches the program into its instruction buffer and then begins executing. Each PIM operation is sent to one or more bank control units. The bank control unit understands how PIM structures are mapped to a vertical layout and how they are partitioned across subarrays so that a single PIM command can leverage SALP. Because traditional address interleaving means PIM operations use all channels, ranks, and banks (depending on data size), regular memory read/write (from any process, including the PIM process) must stall until the RLU indicates the completion of a PIM program.

When the RLU signals the completion of the PIM program, which requires an additional 1-bit signal, the memory con-troller transfers control back to the CPU. The jpim instruction completes when all the memory controllers have returned. And the CPU can retrieve the results with a command to read the appropriate data from the PIM, which the RLU services. Note that this approach means this core is not interruptible, and a PIM kernel is atomic; it cannot be interrupted.

Memory Controllers. Prior work such as SIMDRAM adds decoding and execution logic for each PIM instruction at the memory controller (MC). However, direct PIM support in the MC may not be optimal for scalability and backward compatibility; future PIM products with new functionalities (e.g., instructions) require a new MC design. In this work, the host CPU delegates the MCs to oversee the overall DRAM-BitSIMD kernel execution, which ensures proper execution and synchronization of the kernel among participant RLUs. The RLUs decode and execute instructions that perform the actual DRAM-BitSIMD operations. The DRAM-BitSIMD compatible memory controllers must support PIM and inter-face with the RLU. However, this only requires a few extra signals and some modest logic to schedule memory operations, whether PIM operations or regular read/write. In fact, a typical system contains multiple memory controllers servicing multiple channels. Finally, we adapted a Data Transposition Unit (DTU) design from SIMDRAM that converts input-output data from vertical to horizontal layout and vice versa if needed. We place the DTU in the memory controller so that it has access to any data that are cached in the CPU.

### 7.0 Methodology

Workloads. We select a wide range of applications from three benchmark suites to evaluate DRAM-BitSIMD's performance. Table 2 list all 13 workloads and their respective input data sets. We modify the Binary Search kernel for DRAM-BitSIMD using massively parallel brute-force matching, and replace the Euclidean distance with Manhattan distance in Kmeans to avoid computing square roots.

CPU and GPU Baselines. Our CPU baseline is a 24-core Intel Xeon operating at 2.4 GHz with 128GB 8-channel DDR4 memory, and our GPU baseline is NVIDIA Titan V.

RTL Synthesis of BSLUs. We implement five BSLU variants in RTL and synthesize them with Synopsys Design Compiler and a 14-nm SAED library. Area and power numbers per BSLU are collected from the synthesis tool. We project synthesized results to DRAM by first calculating the number of transistors by dividing the synthesized area by transistor area, where the transistor area is one-fourth of the minimum buffer area in this library (0.0666 um²). Then we assume each transistor can be implemented on DRAM in the area simi-lar to a ITIC memory cell, e.g. typically 4F² in the unit of Fundamental-Feature Square for scaling among technology nodes.

Area Evaluation To estimate the DRAM-BitSIMD chip area, we first use Cacti-3DD [{;] to obtain the area breakdown of the DDR4 chip (Micron_8GB_x4) that is used as the building block. We adopt a DRAM sense amplifier layout described by Song and a patent from Micron for a conventional 4F² DRAM layout. The BSLU is fitted along the sense amplifier's long side. Our RLU is a 1 GHz RISC-V core operating at 9V that consumes 4.86 mm².

Energy Evaluation We assume the background power of a DRAM-BitSIMD chip is always equivalent to the peak power consumption of a DDR4 chip (worst-case assumption). We add 0.45 μW for each additional activated local row buffer to account for the subarray-level parallelism. We calculate the dynamic power consumption of the subarray-level BSLU processing elements for each operation using parameters from our circuit-level modeling. The overall energy consumption in a DRAM-BitSIMD integrated system also includes the power consumption of the host, estimated using the PMC-power tool, and the main memory, calculated by Micron's DRAM power calculator. We estimate each RLU incurs 0.5 W additional power.

Functional and Performance Modeling. We implement an in-house simulator for functional verification and performance modeling. Our simulator can calculate the exact number of DRAM read/write and digital logic operations for each design configuration we explore. To model the application-level speedup, we first vectorize selected benchmarks using a set of DRAM-BitSIMD API calls to emulate kernel execution and then map each API function to DRAM-BitSIMD hardware resources for optimal performance. Since DRAM-BitSIMD adopts an offloading execution pattern where the host is responsible for the resource (DRAM-BitSIMD compute units and memory) allocation, data transferring, and kernel launching, the end-to-end benchmark performance is calculated by adding the host pre-/post-processing time with the DRAM-BitSIMD kernel time. We account for the data preparation latency and energy cost by including (1) the time of data movement be-tween the host memory region and the PIM-eligible region before and after the kernel execution and (2) the data trans-formation latency. The cost of input-output data movement is modeled using Ramulator, and the data transformation cost is modeled using parameters from SIMDRAM.

For modeling DRAM-BitSIMD performance, the embodiments of the present disclosure adopt an approach of building a detailed analytical model for all DRAM-BitSIMD vector API functions that con-sider input characteristics (data type, vector length, etc.) and hardware characteristics (PIM parallelism, micro/macro operation complexity, etc.), and uses the bit-level simulator to drive the timing calculation, adding time to account for RLU and host operations. DRAM parameters are extracted from Ramulator, and the logic operation latency is extracted from our RTL circuit-level modeling. The latency and energy of PIM computing depend primarily on row accesses and the logic complexity of the high-level operation (i.e., add, sub, FP, etc.) at each bit position. We estimate the latency to latch a row of bits into the BSLU registers to be tRCD+tRP (˜30 ns), and the latency to write back from BSLU registers to the memory row to be tWR+tRP (˜30 ns). The latency for BSLU logic is conservatively clocked to match tCCD (2˜Sns). We plan to open-source all code and analytical models.

### 8. Evaluation

BSLU Area and Power. The area, dynamic power, and leakage power of each BSLU variant are shown in Table 3. Area results are projected to DRAM in F² unit.

Insights from our Design Exploration. The figure reports the speedup (SP) and energy reduction (EN) of three DRAM-BitSIMD-3Reg versions with varying degrees of SALP against the CPU. The SALP increases the area and power overhead (See Section 4.1) but improves performance significantly. A 4-way/16-way/32-way SALP design incurs 3.2% 112.8%/25.7% chip area overhead. With only 3.2% area overhead, the 4-way-SALP configuration is a candidate for a memory-first deployment. The most aggressive design (DRAM-SALP32) outperforms the CPU baseline by 2×/425×/20× and reduces energy consumption by 3×/693×/20× (min/max/geomean) and is our best accelerator-first design.

We observe that some benchmarks are not sensitive to the increasing SALP level. For VA, MV, SEL, and BC, the data movement between host memory regions and PIM-eligible regions dominates the execution time (>80%). For HG, the execution time is bounded by the rank-level data aggregation (population count or reduction sum). We leave the exploration of optimal reduction logic placement and strategy for future work. For RED, since all DRAM-BitSIMD variations share the same reduction logic at the rank level, there is no performance difference across different SALP configurations. Accelerating PCA is difficult because PCA requires all input-output vectors to be placed in the same bank due to the lack of support for massively internal data movement across banks, limiting the parallelism potential of bit-serial techniques. We also notice DRAM-BitSIMD achieves comparable speedup and energy savings for floating point vs. integer computation. Finally, energy reduction is highly correlated to the execution time.

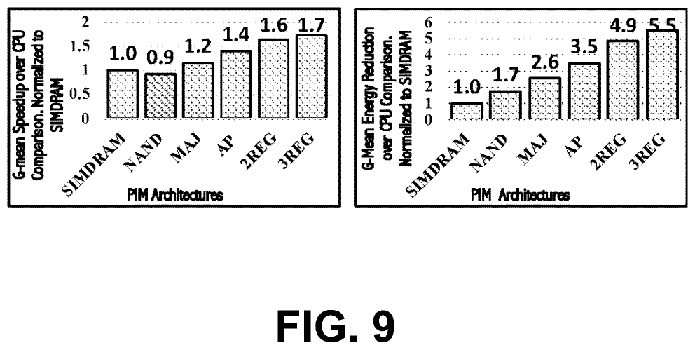

FIG. 9 reports the Geo-mean speedup and energy reduc-tion over the CPU of five proposed BitSIMD designs and SIMDRAM that only implements MAJ/NOT. The results are normalized to that of SIMDRAM, and all architectures share the same SALP level of 32. Note some of the benchmarks (indicated by ‘*’) cannot be handled by SIMDRAM due to the lack of cross-column reduction logic and floating-point implementation. We assume an updated SIMDRAM has these features for a more fair comparison. SIMDRAM only out-performs the NAND-based DRAM-BitSIMD, showing the performance advantage of supporting a larger set of bit-serial operations (see Section 4.2.2). The energy advantage of digital DRAM-BitSIMD is even greater (FIG. 9 right) because the SIMDRAM TRA, and its need for more row access per compute step, incur higher peak power and latency.

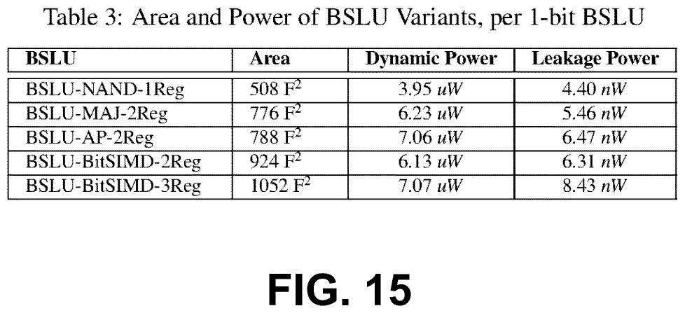

Combining FIG. 9 with the BSLU areas in Table 3 of FIG. 15 also shows that the BitSIMD-2Reg and 3Reg designs are best in terms of raw performance as well as area-and energy-efficiency. The smallest BitSIMD technique that seems viable is AP and is a viable option if area overhead is the overriding concern. But 2-Reg and 3-Reg provide significantly better performance per unit area. We focus on 3-Reg because it provides 1.7× higher multiplication performance even though it is slightly worse (14% BSLU area) than 2Reg in area efficiency.

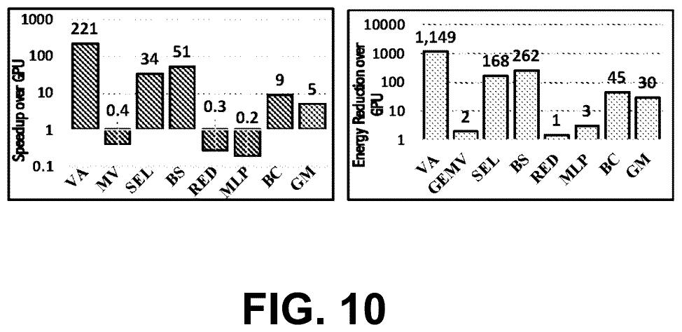

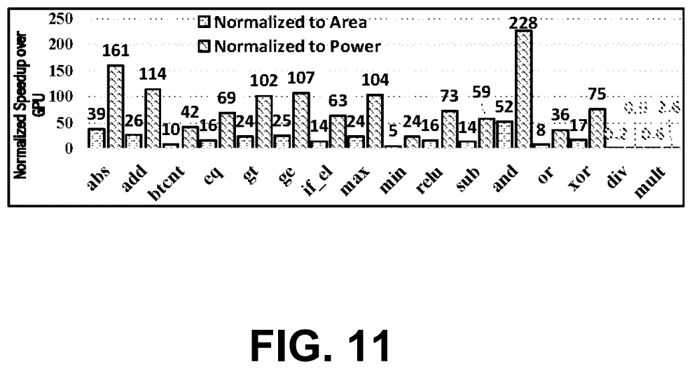

Comparison against GPU. We compare DRAM-BitSIMD designs to GPU using both the same set of 16 compute primitives (32-bit operands) from (FIG. 11), as well as several PrIM benchmarks (FIG. 10). For a fair comparison, we normalize DRAM-BitSIMD's performance to the GPU silicon area (815 mm²) and power consumption (250 W) in FIG. 11, and we exclude data transfer in both cases.

FIG. 10 shows that DRAM-BitSIMD has better power efficiency than area efficiency compared to GPU. DRAM-BitSIMD provides better throughput for logical, relational, and non-quadratic arithmetic (e.g., addition/subtraction) operations than GPU but performs worse for division and multiplication, which has quadratic complexity for bit-serial implementation. This explains the performance degradation for MV and MLP benchmarks, which are multiplication-intensive, and good speedup and energy saving for VA, SEL, BS, and BC workloads, which are dominated by pattern matching and integer ops. RED is limited by rank-level reductions.

The present disclosure explores the design space for subarray-level, bit-serial PIM, including the design space for digital bit-serial logic, for both memory-first (low PIM overhead) and accelerator-first (optimized for PIM) deployment scenarios. We also introduce a rank-level unit (RLU) as a PIM controller, offloading the memory controller and orchestrating the PIM computation at the rank level, and the RLU also performs reductions and other tasks that are not strictly data-parallel. We show that our best bit-serial architecture, the 3-register NOT/AND/OR/XOR/SEL, outperforms the CPU by 20×, GPU by 5×, and SIMDRAM by 1.7×, and is substantially more energy-and area-efficient.

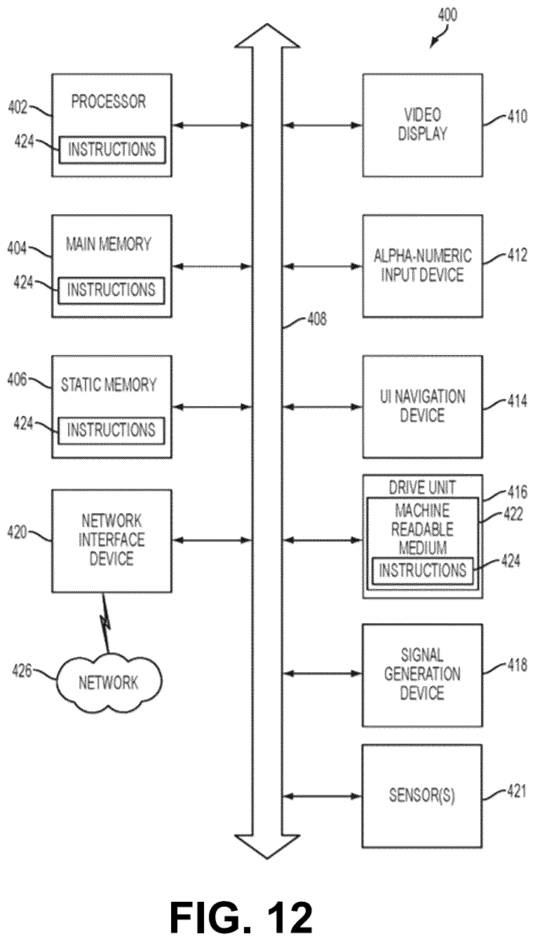

Referring to FIG. 12, an aspect of an embodiment of the present invention includes, but not limited thereto, systems, circuits, methods, computer readable medium, and articles of manufacture that provides one or more of the following: a) DRAM-based bit-serial vector computing architecture, b) bit-serial vector computing embedded in the DRAM subarray, leveraging the massive parallelism of DRAM row operations, c) subarray-level, bit-serial PIM, including the design space for digital bit-serial logic, for both memory-first (low PIM overhead) and accelerator-first (optimized for PIM) deployment scenarios, and d) rank-level unit (RLU) as a PIM controller, offloading the memory controller and orchestrating the PIM computation at the rank level, and wherein the RLU also performs reductions and other tasks that are not strictly data-parallel, which illustrates a block diagram of an example machine 400 upon which one or more embodiments (e.g., discussed methodologies) can be implemented (e.g., run).

Examples of machine 400 can include logic, one or more components, circuits (e.g., modules), or mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) can be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit can be implemented mechanically or electronically. For example, a circuit can comprise dedicated circuitry or logic that is specifically configured to perform one or more techniques such as discussed above, such as including a special-purpose processor, a field programmable gate array (FPGA) or an application-specific integrated circuit (ASIC). In an example, a circuit can comprise programmable logic (e.g., circuitry, as encompassed within a general-purpose processor or other programmable processor) that can be temporarily configured (e.g., by software) to perform the certain operations. It will be appreciated that the decision to implement a circuit mechanically (e.g., in dedicated and permanently configured circuitry), or in temporarily configured circuitry (e.g., configured by software) can be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor can be configured as respective different circuits at different times. Software can accordingly configure a processor, for example, to constitute a particular circuit at one instance of time and to constitute a different circuit at a different instance of time.

In an example, circuits can provide information to, and receive information from, other circuits. In this example, the circuits can be regarded as being communicatively coupled to one or more other circuits. Where multiple of such circuits exist contemporaneously, communications can be achieved through signal transmission (e.g., over appropriate circuits and buses) that connect the circuits. In embodiments in which multiple circuits are configured or instantiated at different times, communications between such circuits can be achieved, for example, through the storage and retrieval of information in memory structures to which the multiple circuits have access. For example, one circuit can perform an operation and store the output of that operation in a memory device to which it is communicatively coupled. A further circuit can then, at a later time, access the memory device to retrieve and process the stored output. In an example, circuits can be configured to initiate or receive communications with input or output devices and can operate on a resource (e.g., a collection of information).

The various operations of method examples described herein can be performed, at least partially, by one or more processors that are temporarily configured (e.g., by software) or permanently configured to perform the relevant operations. Whether temporarily or permanently configured, such processors can constitute processor-implemented circuits that operate to perform one or more operations or functions. In an example, the circuits referred to herein can comprise processor-implemented circuits.

Similarly, the methods described herein can be at least partially processor-implemented. For example, at least some of the operations of a method can be performed by one or processors or processor-implemented circuits. The performance of certain of the operations can be distributed among the one or more processors, not only residing within a single machine, but deployed across a number of machines. In an example, the processor or processors can be located in a single location (e.g., within a home environment, an office environment or as a server farm), while in other examples the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) can be implemented in digital electronic circuitry, in computer hardware, in firmware, in software, or in any combination thereof. Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computer or on multiple computers at one site or distributed across multiple sites and interconnected by a communication network.

In an example, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 400) and software architectures that can be deployed in example embodiments.

In an example, the machine 400 can operate as a standalone device or the machine 400 can be connected (e.g., networked) to other machines.

In a networked deployment, the machine 400 can operate in the capacity of either a server or a client machine in server-client network environments. In an example, machine 400 can act as a peer machine in peer-to-peer (or other distributed) network environments. The machine 400 can be a personal computer (PC), a tablet PC, a set-top box (STB), a Personal Digital Assistant (PDA), a mobile telephone, a web appliance, a network router, switch or bridge, or any machine capable of executing instructions (sequential or otherwise) specifying actions to be taken (e.g., performed) by the machine 400. Further, while only a single machine 400 is illustrated, the term “machine” shall also be taken to include any collection of machines that individually or jointly execute a set (or multiple sets) of instructions to perform any one or more of the methodologies discussed herein.

Example machine (e.g., computer system) 400 can include a processor 402 (e.g., a central processing unit (CPU), a graphics processing unit (GPU) or both), a main memory 404 and a static memory 406, some or all of which can communicate with each other via a bus 408. The machine 400 can further include a display unit 410, an alphanumeric input device 412 (e.g., a keyboard), and a user interface (UI) navigation device 411 (e.g., a mouse). In an example, the display unit 810, input device 417 and UI navigation device 414 can be a touch screen display. The machine 400 can additionally include a storage device (e.g., drive unit) 416, a signal generation device 418 (e.g., a speaker), a network interface device 420, and one or more sensors 421, such as a global positioning system (GPS) sensor, compass, accelerometer, or other sensor.

The storage device 416 can include a machine readable medium 422 on which is stored one or more sets of data structures or instructions 424 (e.g., software) embodying or utilized by any one or more of the methodologies or functions described herein. The instructions 424 can also reside, completely or at least partially, within the main memory 404, within static memory 406, or within the processor 402 during execution thereof by the machine 400. In an example, one or any combination of the processor 402, the main memory 404, the static memory 406, or the storage device 416 can constitute machine readable media.

While the machine readable medium 422 is illustrated as a single medium, the term “machine readable medium” can include a single medium or multiple media (e.g., a centralized or distributed database, and/or associated caches and servers) that configured to store the one or more instructions 424. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media. Specific examples of machine readable media can include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

### Another DRAM-BitSIMD Architecture

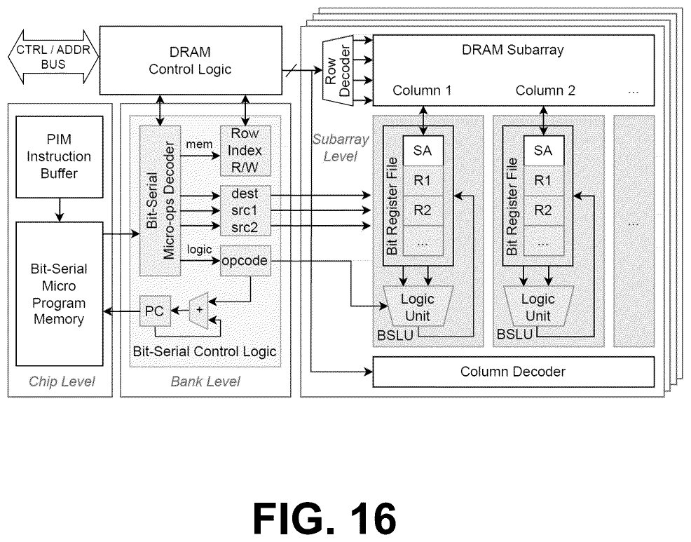

FIG. 16 illustrates another DRAM-BitSIMD architecture. The high-level DRAM-BitSIMD architecture we use to evaluate the design tradeoffs discussed above is shown as FIG. 16. It includes the following components.

Subarray-Level Bit-Serial Logic Unit (BSLU). This is the bit-serial processing element per subarray column. It includes logic circuit to perform various bit-serial operations, bit registers, and register addressing logic. In PIM computing mode, within each subarray, BSLUs associated with each column are operated in lockstep. The bit-serial ISA of each BSLU variant includes a unique set of bit-serial logic operations described in Section V-B1, common register move/set operations, and regular memory row read/write.

Bank-Level Bit-Serial Control Logic. At bank level, there is control logic for decoding bit-serial micro-ops and sending control signals to all BSLUs within the bank. For memory read/write operations, the control logic decodes the row index and sends the signals for reading a memory row to the SA or writing the SA to a memory row. For bit-serial logic operations, the decoder looks up the opcode, source, and destination registers, and then sends control signals to the BSLUs to perform the computation. The control logic fetches and decodes micro-ops from a bit-serial micro program memory (Section VI-C). The bit-serial micro program supports jump and loop syntax to reduce micro program size.

PIM Instruction Buffer and Bit-Serial Micro Program Memory. At the DRAM chip level, a PIM instruction buffer stores a sequence of high-level PIM vector instructions for a PIM kernel. Host CPU is responsible for writing PIM vector instructions into this buffer before transferring control flow to the PIM device. Each PIM vector instruction is then mapped into a bit-serial microprogram stored in a separate read-only memory for execution, using opcodes as indices. We estimate the size of PIM instruction buffer as 1 KB and bit-serial micro program memory as 10 KB.

### V. Design Space to Explore

The design space of in-situ bit-serial PIM architectures is characterized by several key parameters, including deployment models, power and area constraints, hardware design limitations, programmability aspects, and performance considerations. This section examines each of these in detail and enumerates potential design options.

### A. Deployment Models

Memory-First Deployment. In the memory-first model, area overhead and memory capacity become key considerations as we seek to integrate PIM features into conventional DRAM design constraints. We also need to split memory space for regular usage and PIM computation and consider system integration details such as virtual/physical addresses and memory paging. Thus, the PIM capability can be installed in a few subarrays of the DRAM at most, so that area and power overheads are small. We explore configurations that fit within an area/power overhead budget of 5% or less, and discuss potential system integration solutions in Section VI.

Accelerator-First Deployment. In this model, the PIM computation capability can be installed in a large portion of subarrays, providing us with the flexibility to explore designs that offer varying degrees of subarray-level parallelism (SALP). Although the chip organization such as channels, ranks, and banks can be adjusted or enlarged as a stand-alone accelerator, here we follow the traditional DRAM organization for simpler analysis. The area overhead of bit-serial logic introduces tradeoffs of performance and capacity given fixed chip area. Because sense amplifiers (SAs) are shared by two adjacent subarrays, up to 50% of subarrays can be activated simultaneously and perform PIM computation, while the remaining subarrays can be used for storing data or supporting another PIM context in a time-sharing manner.

### B. Complexity of the Bit-Serial Logic

The level of complexity of the bit-serial logic not only affects programmability but has important performance considerations. First, keeping the bit-serial logic simple implies that the number of bit-serial operations required to realize high-level arithmetic and logic operations would increase. Second, and more importantly, it could impact the number of row accesses required for storing intermediate results. Note that row accesses are more costly than logic operations as each memory-row read or write takes a full row activation and precharge cycle, typically 30-50 ns. On the other hand, bit-serial logic operations that only use the value in the local row buffer and local registers can operate faster, at a cycle time determined by the control signal propagation latency across all columns, which is modeled as tCCD, i.e., the delay between consecutive column commands, typically 10× faster than a row access cycle, so performance is largely dominated by row access. The running time of a bit-serial program is the sum of the execution time of all row accesses and bit-serial operations in this program. This measurement is pessimistic because some bit-serial operations can potentially overlap with row accesses with proper control sequence or pipelining.

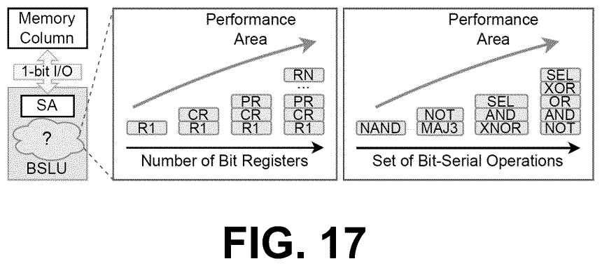

We explore the design space of bit-serial logic units (BSLU) based on 1T1C DRAM architecture. In a PIM-enabled subar-ray, each column has a BSLU pitch-matched and attached to the SA. With vertical data layout, a row read operation can read a bit slice from the memory array to the local row buffer, and a row write operation can write all bits stored in the local row buffer to a specific bit slice—i.e., row—in the memory array. All the BSLUs operate in a lockstep, SIMD style. FIG. 17 shows the model of a BSLU, where row accesses can be abstracted as 1-bit I/O, and the SA (sense amp) is a 1-bit register that contains a copy of the actual sense amp latch contents. The design space of the bit-serial logic then includes (a) the set of bit-serial operations, and (b) the number of bit registers in addition to the SA. Since performance is largely dominated by row accesses, the goal of designing the logic within BSLU is to reduce the number of row accesses, and secondarily to minimize the number of logic operations needed to synthesize a more complex task, such as arithmetic, while minimizing the area of the BSLU.

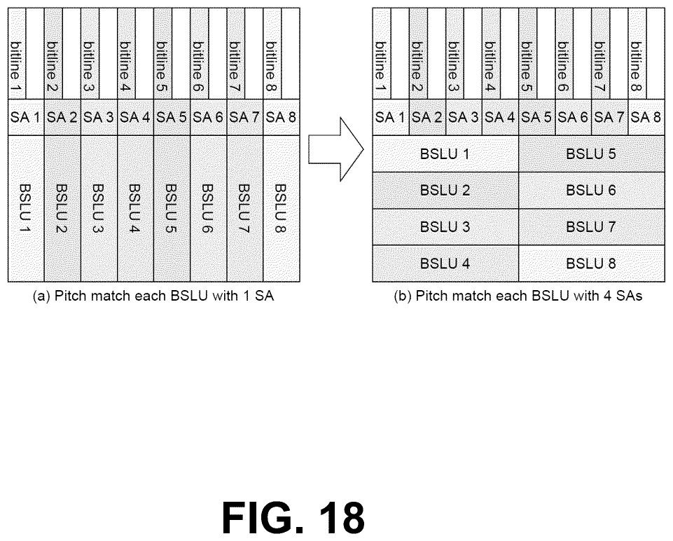

Pitch matching a BSLU circuit with one sense amplifier creates routing challenge due to the narrow channel region, thus we apply a tiling strategy to pitch match a BSLU to two or more sense amplifiers. A potential BSLU tiling strategy is shown in FIG. 18 for one side of the subarray. With 6 F 2 DRAM cell, the typical bitline width is 2 F, and the width of a sense amplifier is 4 F with open bitline architecture. From our area estimation, the area of BitSIMD-Flex-3Reg BSLU is equivalent to 263 DRAM cells, i.e. 263 6 F² area. If we pitch match this BSLU to one SA, the BSLU dimension is 4F 400 F. If we pitch match this BSLU to 4 SAs, the BSLU dimension is 16 F 100 F, which is easier to route.

1) Set of Bit-Serial Operations: Due to hardware cost, a BSLU can only support a small set of primitive bit-serial in-structions. We study 6 representative bit-serial instruction sets and analyze performance and area trade-offs. More bit-serial operations result in better performance but higher hardware costs. All BSLU variants support common move and set op-erations and random register addressing for programmability.

NAND-only (nand): A minimal logic complete design.

DRISA-nor (and/or/nor): This matches with DRISA-nor 1T1C design, with a NOR gate attached to SA. DRISA sup-ports AND and OR operations based on Triple Row Activation (TRA), while the NOR operation itself is logic complete.

DRISA-mixed (and/or/not/nand/nor/xnor): This matches with DRISA-mixed 1T1C design with multiple logical operations attached to SA.

MAJ (maj/not): This is a digital version of SIMDRAM, with a 3-operand majority operation to simulate Triple Row Activation (TRA), and with a NOT operation.

AP (and/xnor/sel): This is for modeling Associative Processing, with XNOR for bit matching and SEL (2:1 MUX) for conditional update. With AND operation, this BSLU can compare a sequence of bits efficiently. The AND/XNOR provide a digital approximation of FlexiDRAM, but AP adds SEL.

Flex (not/and/or/xor/sel): We consider this set of operations as a flexible general purpose setup with good balance between hardware cost and performance.

No Register: Analog in-situ PIM does not require registers, and model analog SIMDRAM as a no-register baseline in our performance evaluation. But for digital PIM, if a sense amplifier can only sense one bit value at a time, we need at least one latch or register to hold a temporary value to perform a 2-operand operation.

1-Reg: With one additional bit register besides SA, the BSLU can perform two-operand Boolean operations. With a logic complete set of bit-serial operations, the BSLU can compute complex tasks. But the performance is limited due to the need of storing intermediate values in memory rows.

2-Reg: By adding one more bit register, the BSLU can store a temporary bit value locally which can significantly reduce the number of row accesses, such as the carry bit during integer addition. In addition, the BSLU can support three-operand operations such as conditional selection (SEL).

3-Reg: Adding 3-bit registers provides more room to store temporary values during complex tasks such as integer multiplication and floating-point arithmetic. Although all BSLUs operate in SIMD style, complex tasks often require column-specific operations based on a condition. For example, for integer vector multiplication A×B=Prod, we may read out a bit slice of A, and use it as a condition to determine in which columns we need to shift and add B to Prod. Thus, BitSIMD variants AP and Flex that support SEL operation can significantly reduce register spilling during multiplication. Other variants without SEL can also benefit from 3-bit registers to store more intermediate values during computation.

4-Reg: Simpler instruction sets require more intermediate registers; for example, AP requires 4 registers to avoid spilling on multiplication, while Flex requires only 3. This allows us to examine interesting design tradeoffs due to the interplay of simple vs. complex instruction sets and the number of registers supported, and their impact on performance and area/power overhead.

More registers: More efficiency can be gained with additional registers, but with diminishing returns, and the logic overhead becomes increasingly difficult to pitch-match.

### VI System Integration

This section describes the software and hardware features that enable interaction with the host system. We adopt a kernel offloading model, where programmers manually partition the workload. We employ this simplified approach to the programming aspect because our work is primarily focused on architectural exploration and trade-off analysis.

### A. Programming and Compiling

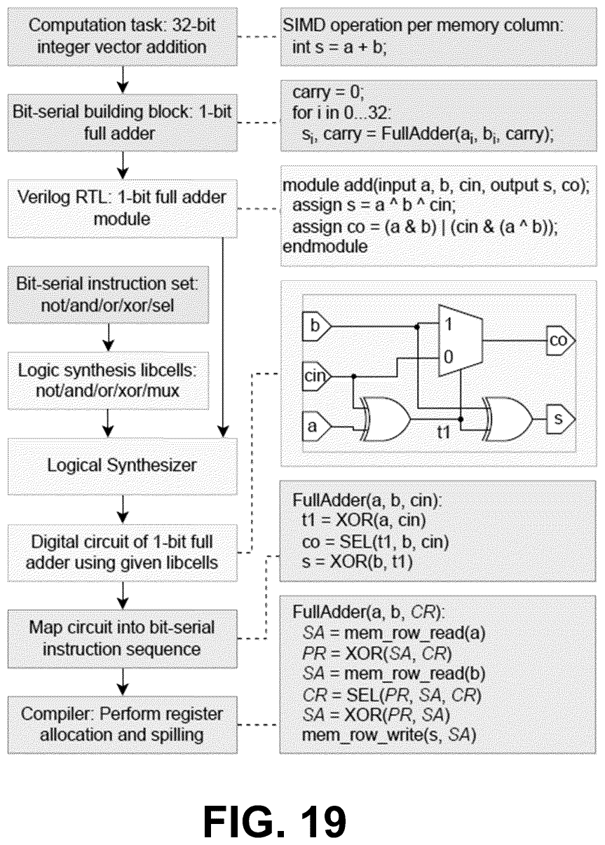

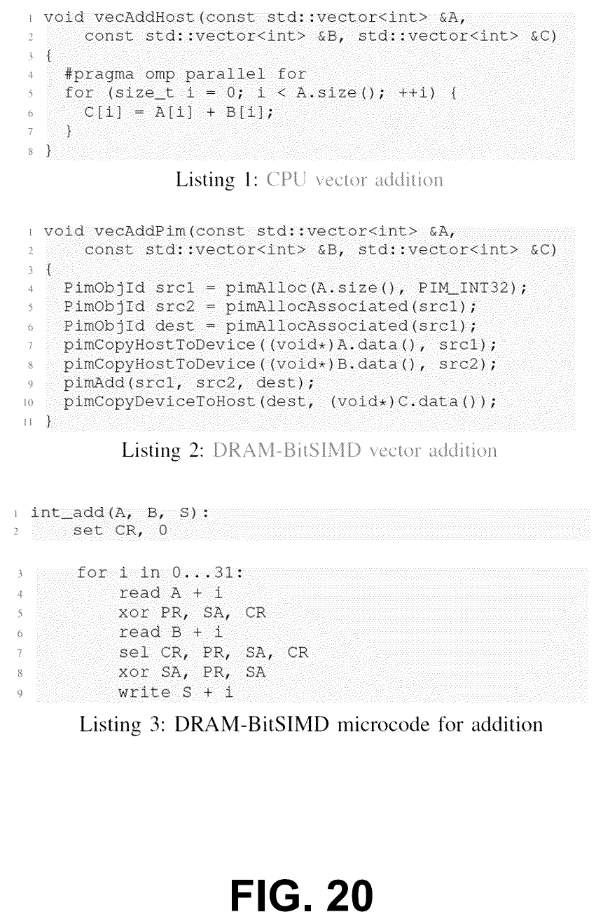

1) Bit-Serial Microcode: Because the bit-serial architecture uses only a small number of elementary logic elements, writing the microprogram for a bit-serial operation benefits from logic synthesis tools, which can identify the sequence of operations using these hardware elements and any intermediate values. FIG. 19 demonstrates how to map a high-level computation task to a bit-serial microprogram for DRAM-BitSIMD. Given a computation task such as 32-bit integer addition, we first rewrite it in a bit-serial way by calling some basic building blocks such as 1-bit full adder. Then, we create Verilog RTL⁴ code for that 1-bit full adder and use logic synthesis tools to ⁵ map the functionality into a specific BSLU ISA by treating the BSLU ISA as available libcells for synthesis. Finally, we ⁸ map the resulting circuit into a bit-serial microprogram, using compiler techniques such as instruction scheduling, register allocation, and spilling.

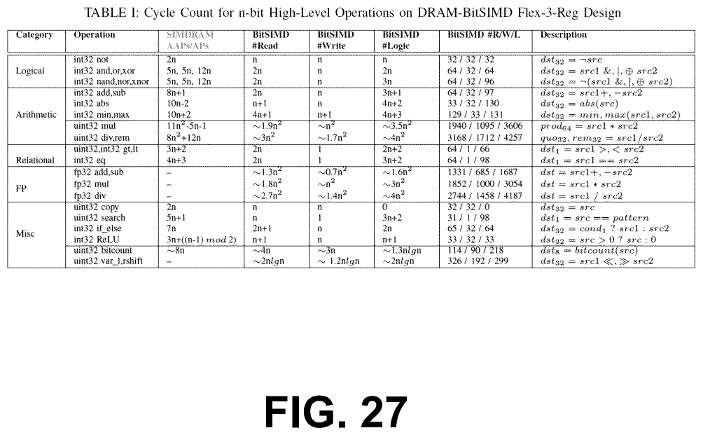

2) High Level Operations: Our architecture provides a unique set of high-level operations meticulously designed to be compatible with typical vector instruction set (see Table I of FIG. 27). These operations include bitwise logical, integer arithmetic, integer relational, floating-point arithmetic, and other supporting operations. With the decoupled row access and bit-serial operation execution, we collect the number of row read, row write, and logic operations separately from a functional simulator. Note that the bit-serial microprograms can likely be optimized further, and the architecture can support more data types and operations.

### Integer Arithmetic, Relational, and Logic Operations

FIG. 19 shows the microprogram for integer addition. It minimizes row accesses to just reading out each bit of the two operands and writing back the results by taking advantage of the bit registers (CR/PR) and complex bit-serial operations (XOR/SEL) in the Flex 2-Reg or 3-Reg models. Subtraction 1 is similar to addition, and integer relational operations are implemented based on subtraction, with the necessary sign bit check. If not directly supported by the logic gates in the BSLU, Boolean logic operations are implemented using a short microprogram.

The basic shift-and-add approach for integer multiplication has O(n2) complexity. We implement unsigned integer multiplication with one level of Karatsuba recursion then fall back to the shift-and-add approach. We implement the shift-and-sub approach described in for division. Bit-serial addition or subtraction can be done on two ranges of bits, i.e. row indices, without the need for shifting the data.

Floating-point Arithmetic. One of the main challenges with FP arithmetic is that mantissa alignment and result normalization require data-value-specific shifting steps, which contradicts the principles of SIMD. We implement the variable shifting in log-linear complexity by performing conditional shifting with 2i stride.

Miscellaneous Operations. We can also effectively search for an exact pattern among data elements in all columns by encoding the pattern as part of a bit-serial microprogram. The bit-serial ISA supports bit population count (pop count) and variable shift in log-linear complexity.

3) Application Development: We assume a kernel-offloading model and envision that an expert programmer manually identifies kernels to offload and rewrites the applications using custom APIs.

As a simple, illustrative example, Listings 1 and 2 show two code snippets for the baseline CPU program, and the equivalent DRAM-BitSIMD code for Vector Addition. As seen in the DRAM-BitSIMD code (Listing 2), it uses custom APIs such as pimAlloc( ) pimCopy( ) pimAdd( ) We have developed these high-level APIs to cover PIM memory allocation, object association, data transfer, and vector computation, so that kernels can be implemented using these APIs, keeping the programs independent of BSLU details.

Compilation. DRAM-BitSIMD uses two levels of ISA. The low level (Section IV) is the DRAM-BitSIMD bit-serial micro-ops ISA. The high level (Section VI-A2 and Table I) consists of extensible DRAM-BitSIMD high-level operations, i.e. macros, that manipulate vectors and exposed to the programmer as APIs as can be seen in listing 2. Each macro defines semantics that are independent of BSLU architectural details, and implemented as a microprogram of low-level BSLU ops. For example, pimAdd( ) maps to the micro code in Listing 3. This decouples code generation from the specific PIM architecture, leaving room for hardware and software changes while providing a clean abstraction for application and compiler developers. DRAM-BitSIMD kernel and host codes are compiled separately. The kernel is compiled into sequences of high-level DRAM-BitSIMD instructions (Section VI-A2) which then translate to pre-programmed bit-serial micro-programs stored in a bit-serial instruction memory. We list the number of row read/write and logic operations needed by each BitSIMD high-level operation in Table I of FIG. 27. We also list SIMDRAM APs/AAPs in a column for comparison. Each AP operation performs a multi-row activation and a precharge. Each AAP operation performs two single-or multi-row activations and one precharge. This shows the dramatic reduction in costly row precharge/activation enabled by digital PIM with enough registers to avoid spilling intermediate values.

### B Interconnect, Memory Management, Data Transposition

In this work, we incorporate Compute Express Link (CXL) as our interconnect for several reasons. First, it facilitates coherent memory access among devices and hosts, ensuring transparent data movement across the system.

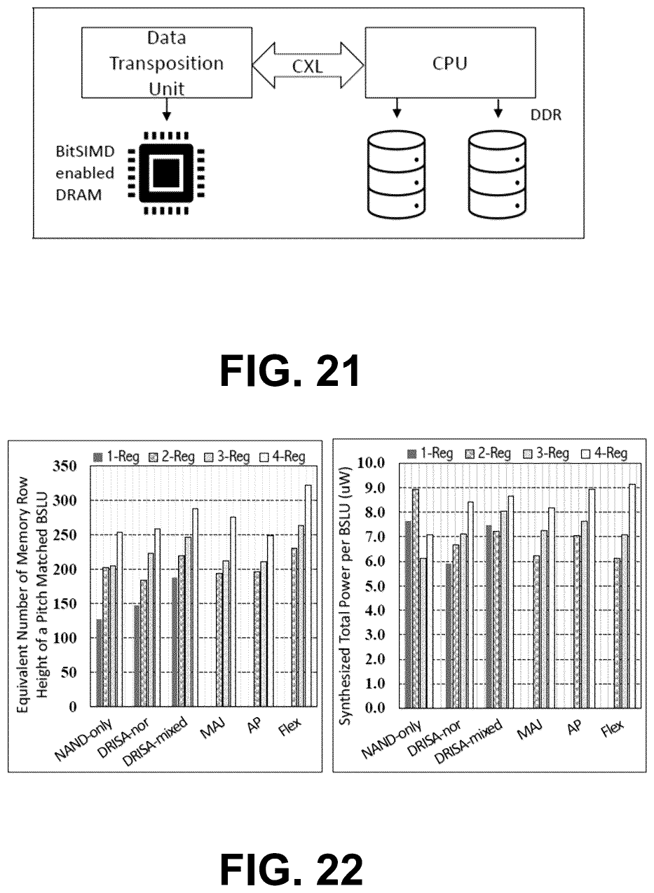

Second, it enables multi-core hosts to continue executing applications by providing uninterrupted access to host memory while PIM operations are ongoing. Third, CXL uses PCIe as its underlying physical layer, thereby ensuring a higher memory bandwidth. For example, DDR4 3200 MHz provides a bandwidth of 25.6 GB/s, while CXL provides 40 GB/s read/write bandwidth. Finally, CXL-based PIM avoids modifications to the CPU chip, as both the PIM instruction fetch and decode units, as well as the data transposition unit, can be transparently integrated into the CXL controller, making the PIM integration adaptable to a variety of CPUs (FIG. 21). Furthermore, with CXL integration, we avoid the need to reserve large portions of the host memory for PIM.

Prior work such as SIMDRAM adds decoding and execution logic for each PIM instruction at the memory controller. However, direct PIM support in the memory controller may not be optimal for scalability and backward compatibility; future PIM products with new functionalities (e.g., instructions) require a new memory controller design, which must be integrated into new CPUs. This work uses bank-level control logic in the PIM memory to fetch, decode, and dispatch bit-serial micro-ops from a chip-level memory to subarrays. The PIM computation is set up using conventional CXL memory reads and writes. We adapt the data transposition unit from SIMDRAM that converts input-output data from vertical to horizontal layout and vice versa as needed, and place it in the CXL switch, making it transparent to both the host and the PIM device.

### C. Kernel Launch

On the PIM device, we introduce a PIM instruction buffer and a bit-serial microprogram memory to facilitate PIM processing (FIG. 16). PIM operation is exposed to the processor with macro-ops for conventional vector operations, such as integer/floating point operations on vectors of 8-bit, 32-bit, etc. elements. A PIM macro-op is applied to an object allocated in PIM memory. We adopt the approach for PIM memory allocation and integration with virtual memory introduced by SIMDRAM. To perform a PIM operation, the memory controller switches the memory to PIM mode, similar to prior PIM proposals, and writes the macro-op and operand address ranges to a reserved address using CXL.io.

Each macro-op is implemented in the PIM device using microcode, i.e., a sequence of the natively-supported Boolean operations (e.g., not/and/or/xor/sel for Flex), stored in the microprogram memory. At the chip level, the PIM device uses the macro-op to index the microprogram memory and start executing the microprogram sequence. At bank level, the bit serial control logic maintains a PC and fetches the bit-serial micro-ops for execution, with basic loop support to reduce code size. The bit-serial micro-op fetching and decoding are done in a pipeline, so that we can execute one micro-op per tCCD cycle. We assume there is a single CPU thread interacting with the PIM device, and we leave context switching for future work.

We consider PIM-enabled subarrays and typical subarrays as separate memory space, and host CPU can access them through CXL interface. When PIM-enabled subarrays are performing PIM operations, host CPU can still access non-PIM subarrays, but regular read/write requests to PIM-enabled subarrays will be stalled. The memory controller can interleave PIM and memory read/write requests even to PIM-enabled subarrays, because the BSLU state is not used in read/write, and thus is preserved until PIM operation resumes. The memory controller initiates PIM operations at the granularity of macro-ops, whose latency is deterministic. So the only restriction on interleaving PIM and read/write is that the memory controller should wait for one macro-operation to complete, to avoid the need to pause the microcode sequence. An alternative would be to implement the microcode in the memory controller, but this is left for future work.

### VII METHODOLOGY

Benchmarks. A wide range of applications are selected from prior work on PIM aiming to capture a variety of behaviors. Sparse applications, such as SpMV, are omitted, because the bit-serial approach does not support the indirection of sparse formats such as CSR. The benchmarks used in this paper include Convolutional Neural Networks (CNNs) such as VGG-13 and VGG-16. CNNs use many floating point multiplications in their convolution and dense layers. However, bitcount and XNOR can replace the expensive multiplications.

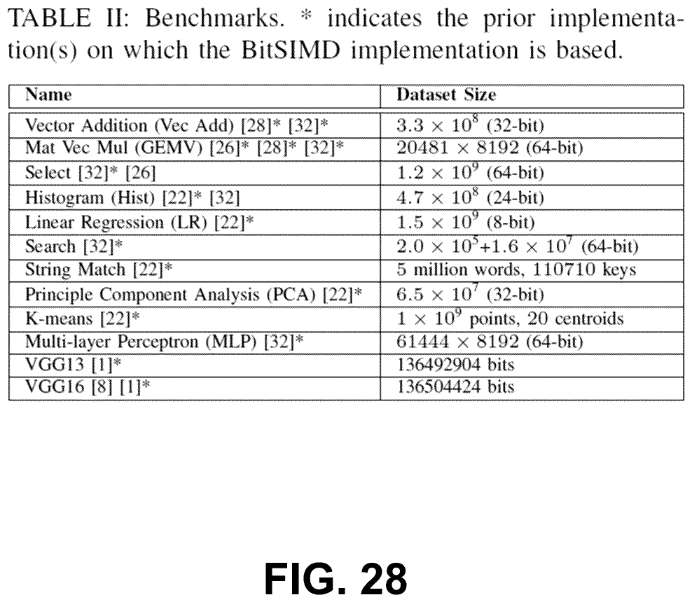

We use the Xnor-net variant of VGG-13 and VGG-16 following the approach in SIMDRAM. Table II of FIG. 28 shows the benchmark list.

Baseline Architecture. Our CPU and GPU baseline are AMD EPYC7742 64-Core and NVIDIA A100.

RTL Synthesis of BSLUs. To obtain area and power estimates, we implement all proposed BSLU variants in RTL, synthesized with Synopsys Design Compiler and a 14-nm SAED library, considering timing constraints and routing overhead. We then scale the SAED library to a more state-of-the-art 14 nm library from TSMC based on the ratio of minimum transistor sizes.

Area Evaluation The DRAM chip area overhead of our solution consists of three parts, the subarray level BSLUs per column, the bank-level bit-serial control logic, and the chip-level bit-serial micro-program storage. The data transposition unit is integrated into CXL interface, which is not considered part of DRAM chip area overhead.

We scale our RTL synthesis results to DRAM area and estimate the area overhead based on a key assumption that the minimum transistor area in our digital library is approximately the same as a 1T1C memory cell area on DRAM. Comparing the minimum transistor area in the TSMC 14 nm logic process to the area of one 1T1C cell in Micron's 14 nm logic process, we find both are approx. 0.003 um². Rather than counting the actual number of transistors in the synthesized circuit, we conservatively divide the synthesized area by the minimum transistor area, to account for gate sizing and routing impact. This gives the BSLU area in terms of number of minimum-transistor equivalents, and thus in terms of DRAM 1T1C cells. According to this methodology, a bit register is roughly equivalent to 14 16 1T1C DRAM cells, and the area of the digital BSLUs ranges from 128-321 1T1C cells, and since each sense amp is associated with one BSLU, this translates to an area equivalent to 128-321 subarray rows. To allow for increased routing area due to the lower number of metal layers in DRAM, we also consider an area expansion factor of 2.0.

We use Cacti-3DD to obtain the area breakdown of the DDR4 chip (Micron_8GB_x4), with 8 banks, 64 subarrays per bank, and 1024 rows and 16384 columns per subarray. Based on the equivalent number of DRAM rows for BSLUs in a subarray, we estimate the area overhead over a subarray. The chip level area overhead is then estimated based on the number of PIM-enabled subarrays, bank-level bit-serial control logic, and chip-level bit-serial micro-program buffer of 10 KB.

Even though the per-subarray overhead is large, when considering the whole DRAM chip, the area overhead is much lower. We use Cacti-3DD to break down the area of an 8 Gb DDR4 DRAM chip. When accounting for the area of the subarrays vs. the rest of the DRAM chip—peripheral logic, control logic, I/O buffers, etc.—using the BitSIMD-Flex-3Reg BSLU (one of our largest variants) increases DRAM chip area by 1.2% with SALP-4 and 6.3% with SALP-32 with expansion factor 1.0.

Energy Evaluation. We assume the background power of a DRAM-BitSIMD chip consistently matches the peak power consumption of a DDR4 chip, adopting a worst-case scenario. We add 0.45 μW for each additional activated local row buffer to account for the subarray-level parallelism. We calculate the dynamic power consumption of the subarray-level BSLU processing elements for each operation using parameters from our circuit-level modeling. The overall energy consumption in a DRAM-BitSIMD integrated system also includes the power consumption of the host, estimated using the PMC-power tool, and the row read/write energy incurred during data movement using methods explained in the Micron datasheet.

Functional and Performance Modeling. We implement an in-house simulator for functional verification and performance modeling. Our simulator can calculate the exact number of row read/write and digital logic operations for each design we explore. To model the application-level speedup, we first vectorize selected benchmarks using a set of DRAM-BitSIMD API calls to emulate kernel execution and then map each API function to DRAM-BitSIMD hardware resources for optimal performance. Since DRAM-BitSIMD adopts an offloading execution pattern where the host is responsible for the resource (DRAM-BitSIMD compute units and memory) allocation, data transferring, and kernel launching, the end-to-end benchmark performance is calculated by adding the host pre-/post-processing time with the DRAM-BitSIMD kernel time. We account for the data preparation latency and energy cost by including (1) the time of data movement between the host memory region and the PIM-eligible region before and after the kernel execution and (2) the data transformation latency. The cost of input-output data movement is modeled using Ramulator, and the data transformation cost is modeled using parameters from SIMDRAM.

For modeling DRAM-BitSIMD performance, we adopt the same approach as by building a detailed analytical model for all DRAM-BitSIMD vector API functions that consider input characteristics (data type, vector length, etc.) and hardware characteristics (PIM parallelism, micro/macro operation complexity, etc.), and uses the bit-level simulator to drive the timing calculation, adding time to account for host operations. DRAM parameters are extracted from Ramulator, and the logic operation latency is extracted from our RTL circuit-level modeling. The latency and energy of PIM computing depend primarily on row accesses and the logic complexity of the high-level operation (i.e., add, sub, FP, etc.) at each bit position. We estimate the latency to latch a row of bits into the BSLU registers to be tRCD+tRP (30 ns), and the latency to write back from BSLU registers to the memory row to be tWR+RP (30 ns). The latency for BSLU logic is conservatively clocked to match tCCD (2 5 ns). We plan to open-source all code and analytical models.

### VIII. Evacuation

Area and Power Analysis. FIG. 22 (left) shows the area overhead for a bitslice of BSLUs in terms of the equivalent number of subarray rows. However, the subarrays only comprise part of the DRAM chip. As noted previously, when scaled out to evaluate area overhead for the full DRAM chip, the area overhead for digital PIM with 32-way SALP and an expansion factor of 1.0 is only 6.3% for Flex-3Reg, and 12.6% for an expansion factor of 2.0.

Dynamic power dominates leakage power by a factor of about 1000, so we only present total power from synthesis results. Note that supporting more sophisticated instruction sets does not substantially increase area or power; the number of registers plays a larger role, as demonstrated in FIG. 22 (right). The higher power of NAND-only BSLU with 1-Reg and 2-Reg is because of the P&R noise of the synthesis tool for such small circuit.

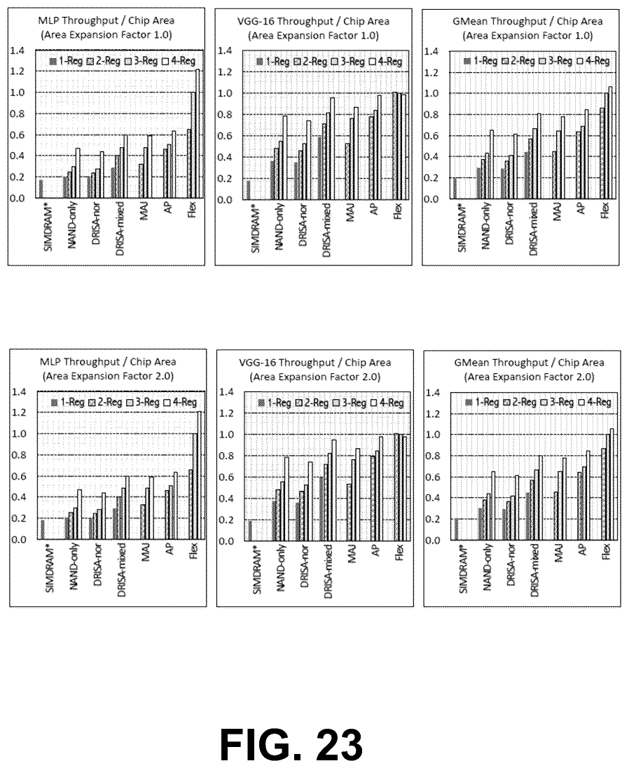

FIG. 23 shows the performance/area for each combination of instruction set and number of registers, normalized to Flex-3Reg, showing two representative benchmarks, MLP and VGG-16, and the geometric mean for all benchmarks. The results are heavily influenced by utilization of addition (e.g., VGG-16) vs. multiplication (e.g., MLP), and how well a given instruction set supports these. They are best supported by the Flex instruction set with at least 3 registers. (In particular, Flex-3-Reg provides 1.7× higher multiplication performance than Flex-2-Reg.) The Associative architecture with 4 registers gives reasonably good overall performance/area, and even slightly outperforms the Flex architecture with 3 registers for VGG, but severely underperforms for multiplication-heavy tasks such as MLP. The leftmost three figures show an expansion factor of 1.0 and the rightmost three show a factor of 2.0. Across the board, the digital techniques with sufficient registers to avoid spilling show significant performance/area advantage over a purely analog, no-register solution such as SIMDRAM; and even though Flex-3Reg has higher area over-head, it still shows a performance/area advantage. However, Flex shows diminishing returns beyond 3 registers, except for benchmarks with significant multiplication, such as MLP.

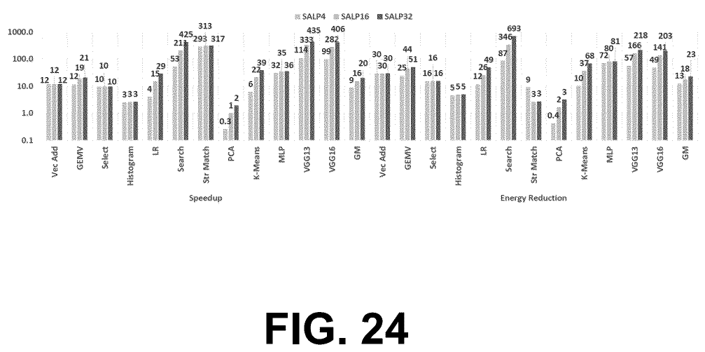

Insights from our Design Space Exploration. FIG. 24 reports the speedup and energy reduction of BitSIMD Flex-3-Reg with varying SALP, against the CPU. While SALP increases the area and power overhead (Section V-A), it significantly improves performance. A 4-way/16-way/32-way SALP design incurs 1.20%/3.37%/6.26% chip area overhead. The 4-or 16-way-SALP design consumes less than 5% area, and is therefore a candidate for memory-first deployment. The most aggressive design (SALP32) outperforms the CPU by 2×/435×/20× and saves 3×/693×/23× (min/max/geomean) in energy, and is thus our best accelerator-first design.

We observe that some benchmarks are not sensitive to the increasing SALP level. For vector add, matrix-vector multiplication, and select, the data movement between host memory regions and PIM-eligible regions dominates the execution time (>80%). For histogram, the execution time is bounded by the rank-level data aggregation (population count or reduction sum). We leave the exploration of optimal reduction logic placement and strategy for future work. Accelerating PCA is difficult because PCA requires all input-output vectors to be placed in the same bank due to the lack of support for massively internal data movement across banks, limiting the parallelism potential of bit-serial techniques. We also notice BitSIMD achieves comparable speedup and energy savings for floating point vs. integer computation. The figure does not include floating point results as they demonstrate similar behavior as their integer variants. Finally, energy reduction is highly correlated to the execution time.

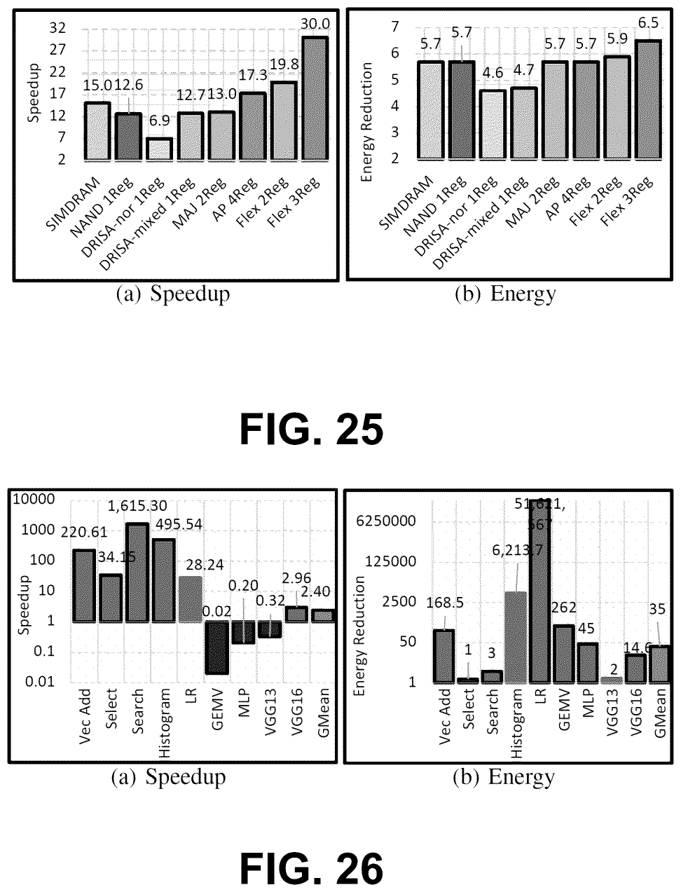

To further understand how the various bit-serial architectures compare, FIG. 25 reports the Geo-mean speedup and energy reduction over the CPU of analog-based SIMDRAM baseline and seven BitSIMD variants, including two digital version of DRISA variants and a digital version of SIMDRAM (MAJ). DRISA supports mixed analog and digital operations.

To ease performance comparison, we convert DRISA analog operations into digital bit-serial operations with additional registers. Such conversion can speed up but not slow down DRISA micro programs. All architectures share the same SALP-32 configuration. SIMDRAM only outperforms the NAND, MAJ, and DRISA-nor options, showing the performance advantage of supporting a larger set of bit-serial operations (Section V-B1). The Flex-3-Reg also shows the best energy reductions compared to the CPU.

Combining FIG. 25 with the BSLU performance/area in FIG. 23 shows that Flex-3-reg and AP-4-reg are the most promising designs, with Flex-3-reg being slightly better over-all, and as mentioned above, showing considerable superiority for multiplication-heavy tasks.

Comparison against GPU. The speedup and energy reduc-tion over GPU has been measured excluding the I/O latency for both Flex-3-Reg and GPU, shown as FIG. 26. Flex-3-Reg provides better throughput for logical, relational, and non-quadratic arithmetic (e.g., addition/subtraction) operations than GPU but performs worse for division and multiplication, which has quadratic complexity for bit-serial implementation. This explains the performance degradation for matrix-vector multiplication and MLP, which are multiplication-intensive, and good speedup and energy saving for vector addition, select, and search workloads, which are dominated by pattern matching and integer ops. Moreover, GPU does not require data re-layout in between kernel steps, whereas Flex-3-Reg requires data transposition for complex kernels such as VGG. As a result, Flex-3-Reg underperforms for the smaller VGG-13 because data restructuring overhead between CNN layers dominates, while the greater PIM activity in the larger VGG-16 allows it to eke out a modest speedup. However, Flex-3-Reg achieves energy savings for all the benchmarks, even when it suffers performance slowdowns, because the DRAM chip is inherently low power, and bit-serial computing minimizes the distance data moves during computation.

Comparison against Bank Level PIM. Another design choice is to add PIM functionalities at the bank level, such as BLIMP-V, Aquabolt, etc. Unlike the BitSIMD design, which requires copying data from host memory to PIM the data read speed is 1 byte per tCCD for a x8 DDR interface, with all banks operating in parallel if associated input data are properly distributed for PIM. Several cycles are needed to fetch each operand. Note that, unlike with the wide data access of HBM, SIMD processing at the bank interface does not help with the narrow interfaces of DDR. Assume there are 128 banks (16 banks/chip with 8 chips), results shows that this bank level computing model is about 2× slower on the benchmark collection than multi-core CPU performance for a single rank, due to the narrow bank interface. Although we have more bank processing units in a rank than CPU cores, the DRAM runs at a much slower clock speed. Performance improves with more ranks and associated parallelism across ranks. In contrast, BitSIMD can achieve 30× speedup over CPU. We also observe that BitSIMD's advantage improves with larger vectors.

Limitations of Bit-serial PIM. Pure bit-serial implementations of operations such as multiplication, division, and floating-point calculations can exhibit quadratic complexity in terms of bitwidth. Another limitation arises from non SIMD access patterns, such as reductions, shuffling, random indexing, and indirection, such as in sparse data formats like compressed sparse row (CSR). While bit-serial PIM can have specialized hardware to support operations, like popcount-based integer reduction or element-wise shifting, it may be more efficient to perform these operations on the host CPU.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a dynamic random access memory (DRAM) that has a memory subarray and a memory bank, the memory subarray being configured for processing in memory (PIM);
the memory subarray comprising:
a plurality of columns in the memory subarray;
a Bit Serial Logic Unit (BSLU) in at least one of the plurality of columns of the memory subarray, the BSLU being configured to execute a bit serial instruction, the bit serial instruction being received from the memory subarray or a bit serial control logic of the memory bank; and
the BSLU execution is decoupled from a read and write DRAM operation for the memory subarray of the DRAM; and
the memory bank comprising the bit serial control logic configured to fetch and decode the bit serial instruction, the bit serial control logic being configured to dispatch the bit serial instruction and a register address signal to the BSLU.

2. The system of claim 1, wherein the plurality of columns are pitch-matched to the memory subarray.

3. The system of claim 1, wherein the BSLU comprises a bit serial logic and a bit register file.

4. The system of claim 1, wherein the BSLU is configured to execute at least one of an XNOR operation, an AND operation, or a SEL operation.

5. The system of claim 1, wherein the BSLU comprises a bit serial logic that is configured to execution at least one of an XNOR operation, an AND operation, or a SEL operation.

6. The system of claim 1, wherein the bit serial control logic is configured to decode a row index from the bit serial instruction.

7. The system of claim 1, wherein the BSLU comprises a plurality of BSLUs which are individually associated with one of the plurality of columns of the memory subarray.

8. The system of claim 1, wherein the BSLU comprises at least a one bit register.

9. The system of claim 1, wherein the BSLU comprises at least a two bit register.

10. The system of claim 1 wherein the BSLU is configured to execute a NAND operation.

11. The system of claim 1, wherein the BSLU is configured to execute at least one of a NOT operation, an AND operation, an OR operation, an XOR operation, or an SEL operation.

12. The system of claim 1, wherein the BSLU comprises an instruction buffer for storing a program.

13. The system of claim 1, wherein the BSLU comprises a bit register file with a sense amplifier.

14. A dynamic random access memory (DRAM) configured for processing in memory, comprising:
a memory subarray with a plurality of columns;
a Bit Serial Logic Unit (BSLU) associated with the plurality of columns of the memory subarray, the BSLU being configured to execute a bit serial instruction, the bit serial instruction being received from the memory subarray or a memory bank; and
the BSLU execution is decoupled from a read and write DRAM operation for the memory subarray of the DRAM;
the memory bank configured to fetch and decode the bit serial instruction, the bit serial control logic being configured to dispatch the bit serial instruction to the BSLU.
